(19) United States
(12) Patent Application Publication
(10) Pub. No.: US 2025/0019307 A1
(43) Pub. Date: Jan. 16, 2025

(54) RAPID SETTING, WATER DURABLE BINDER COMPOSITION

(71) Applicant: UNITED STATES GYPSUM COMPANY, Chicago, IL (US)

(72) Inventors: Yanfei Peng, Hawthorn Woods, IL (US); Ashish Dubey, Grayslake, IL (US); Qinghua Li, Rolling Meadows, IL (US); Feng Peng, Lakemoor, IL (US); Richard Liu, Palatine, IL (US)

(73) Assignee: UNITED STATES GYPSUM COMPANY, Chicago, IL (US)

(21) Appl. No.: 18/625,937

(22) Filed: Apr. 3, 2024

Related U.S. Application Data
(60) Provisional application No. 63/513,415, filed on Jul. 13, 2023.

(51) Int. Cl. C04B 28/18; C04B 7/26; C04B 7/34; C04B 22/14; C04B 24/32; C04B 40/00; C04B 103/20; C04B 103/32; C04B 111/10

(52) U.S. Cl. CPC C04B 28/18; C04B 7/26; C04B 7/34; C04B 22/148; C04B 24/32; C04B 40/0046; C04B 2103/20; C04B 2103/32; C04B 2111/10; C04B 2201/20

(57) ABSTRACT

A rapid setting, water durable binder composition includes a mixture of: a reactive powder including cement, at about 10-40 wt. % of the reactive powder, β-stucco at about 30-75 wt. % of the reactive powder, and pozzolanic material at about 5-30 wt. % of the reactive powder; a plasticizer in an amount equal to about 0.05-3 wt. %, preferably 0.1-3 wt. %, of the reactive powder, and water.

### FIELD OF THE INVENTION

This invention relates to rapid setting, water durable binder compositions which minimize or reduce the formation of ettringite after the mixture hardens. The binder comprises (1) a reactive powder comprising about 10-40 wt. % cement, about 30-75 wt. % β-stucco, and about 5-30 wt. % fly ash and (2) a plasticizer in an amount equal to about 0.05-3 wt. % of the reactive powder.

### BACKGROUND OF THE INVENTION

Ettringite is a compound of calcium aluminum sulfate compound having the formula Ca₆Al₂(SO₄)₃·32H₂O or alternatively 3CaO·Al₂O₃·3CaSO₄·32H₂O. Ettringite forms as long needle-like crystals and provides rapid early strength to cement boards, so they can be handled soon after being poured into a mold or over a continuous casting and forming belt. This is termed primary ettringite formation.

Gypsum-cement chemistry traditionally has a challenge, which is delayed (or secondary) ettringite (hydrous calcium aluminum sulfate Ca₆Al₂(SO₄)₃(OH)₁₂·26H₂O) formation. After the mixture hardens, water exposure and excessive sulfate can lead to secondary ettringite formation, which causes excessive expansion and degradation of the matrix.

The prior art on commercial manufacturing of cementitious boards utilize a highly reactive silica fume to suppress the delayed ettringite formation, but silica fume is very costly. Additionally, α-calcium sulfate hemihydrate (i.e., α-stucco or calcium sulfate alpha hemihydrate) is used in the prior art formulations to provide exceptional strength development but α-stucco is also very expensive.

A fast setting time is desired for enhanced production speed and output in commercial manufacturing environments. The prior art on commercial manufacturing of cementitious boards utilize a high slurry temperature (>120° F.), and chemical accelerators (for example triethanolamine or TEA) to obtain a rapid set.

U.S. Pat. No. 8,038,790 to United States Gypsum, incorporated herein by reference, teaches a non-combustible fire resistant cementitious panel comprising 50-95 wt % reactive powder (comprising 25-75 wt % calcium sulfate alpha hemihydrate, 10-75 wt % hydraulic cement, 0-3.5 wt % lime and 5-30 wt % active pozzolan), 1-20 wt % expanded perlite, 0-25 wt % hollow ceramic microspheres, 3-16 wt % alkali-resistant fibers. The alpha stucco used in this reference is more expensive and has a lower water demand. This reactive powder does not include β-stucco.

U.S. Pat. No. 6,620,487 to United States Gypsum, incorporated herein by reference, teaches the curing of an aqueous mixture of reactive powders comprising 35-75 wt % calcium sulfate alpha hemihydrate, 20-55 wt % hydraulic cement, 0.2-3.5 wt % lime and 5-25 wt % active pozzolan. This reactive powder does not include β-stucco.

U.S. Pat. No. 7,849,649 (US 2006/0174572) to United States Gypsum, incorporated herein by reference, teaches layers from curing of an aqueous mixture of an inorganic binder of 65-75 wt % calcium sulfate alpha hemihydrate, 20-25 wt % Portland cement, 10-15 wt. % an active pozzolan (fly ash is listed as an option) and 0.75-1.25 wt. % lime. This reactive powder does not include β-stucco.

EU 0 271 329 to Commonwealth Scientific and Industrial Research Organisation, incorporated herein by reference, teaches mixtures of calcium sulphate hemihydrate, fly ash and Portland cement. Lime is added to a mixture of 30% hemihydrate, 50% fly ash, and 20% Portland cement in order to increase the conversion of both alumina and calcium sulfate into ettringite. This reference is addressing the primary ettringite formation when the composition is in the fluid phase, as opposed to the secondary ettringite formation (which is undesirable) minimized or reduced by the present invention which typically forms after the mixture hardens.

U.S. Pat. No. 4,350,533 to United States Gypsum Company, incorporated herein by reference, teaches high alumina cement, calcium sulfate, Portland cement, and lime with optional fly ash for commercial manufacturing of cement boards, but does not address using β-stucco or plasticizers. The high alumina cement may also be expensive.

Silica fume is a byproduct of producing silicon metal or ferrosilicon alloys. Because of its chemical and physical properties, it is a very reactive pozzolan. Silica fume is used to suppress secondary ettringite formation because it has superfine particles and is mostly amorphous phase, making it a reactive pozzolan material, but it is very expensive.

US 2011192100A1 to Tonyan et al., Non-Combustible Reinforced Cementitious Lightweight Panels And Metal Frame System For A Fire Wall And Other Fire Resistive Assemblies, incorporated herein by reference, teaches using calcium sulfate alpha hemihydrate, Portland cement, lime and silica fume, while the present invention does not require silica fume.

CN 1061952 to Yangquan Joint, incorporated herein by reference mentions sulfoaluminate cement gypsum, lime and an admixture, which is alkali-metal salt mostly. This is different from the present invention which includes β-stucco and plasticizer.

Other prior art utilizing lime in cement mixtures is found at FR 2289460, U.S. Pat. Nos. 4,488,909, and 9,994,484 (each is incorporated herein by reference). Other rapid-setting cementitious compositions are found at U.S. Pat. Nos. 8,070,878, 6,641,658, 6,869,474, 6,241,815, and US 2020/0039884 (each is incorporated herein by reference).

Prior art on fast setting cementitious systems (U.S. Pat. No. 6,869,474, incorporated herein by reference) utilized an alkanolamine to a hydraulic cement such as Portland cement, and forming a slurry with water under conditions that provide an initial slurry temperature of at least 90° F. High initial slurry temperature is usually achieved by heating up raw materials, which is energy consuming and can complicate the process.

### SUMMARY OF THE INVENTION

It is an object of the invention to provide a rapid setting binder composition with lower delayed ettringite formation, resulting in a stronger binder with good workability and a lower water demand.

It is another object of the invention to provide a more economical method of preparing a binder composition and building products such as cement boards with a rapid set and lower delayed ettringite formation.

The present invention utilizes fly ash (Class C or F, preferably Class F), a by-product of coal combustion process, to suppress delayed ettringite formation to achieve desired long-term durability performance. The calcium oxide present in the fly ash may be embedded in the glass structure of the fly ash particles, wherein the fly ash may have up to 30 wt. %, up to wt. 25%, up to wt. 10%, between 6-24 wt. %, and between 0.1-30 wt. % calcium oxide.

Benefits of the cementitious composition of the present invention include a rapid set (about 10 minutes or about 5 minutes after mixing with water), room temperature (about 40-120° F., preferably 50-100° F., more preferably 40-90° F.), slurry mixing, and in certain embodiments, no traditional chemical accelerators commonly used in Portland cement mixtures such as triethanolamine (TEA), calcium chloride, calcium nitrate, calcium nitrite, calcium formate, calcium aluminates, etc. Setting of the composition is characterized by initial and final set times, as measured using Gilmore needles specified in the ASTM C266 test procedure, as well as high initial compressive strength. The final set time also corresponds to the time when a cement-based product e.g. a cement board, has sufficiently hardened so that it can be handled. It will be understood by those skilled in the art that curing reactions continue for extended periods after the final setting time has been reached. Rapid set is typically a final set time (i.e., the time after which cement boards can be handled) of the cementitious composition as measured according to the Gilmore needle test that should be at most 20 minutes, more preferably at most 10 minutes, or at most 5 minutes, typically 5 to 7 minutes, after mixing. Final set time measured by the Gilmore needle method according to ASTM C266 was the time when no mark was left on a test sample mixture when the Gilmore needle was slowly lowered to the surface of the mixture.

Additional benefits of the cementitious composition of the present invention include good water durability. Water durability is shown with nail pull results and/or flexural strength testing, as described in Example 9. Lightweight cement boards are dried at 70° F. for 24 hours, and dried at 110° F. for 24 hours. After drying, the specimens were soaked in water for 3 hours, 6 hours, 24 hours or 7 days. Good water durability is shown when the nail pull strength results are not negatively impacted with water absorption which is 5-40 wt. % of the total weight of the composition before the water absorption. Good water durability is also shown in flexural strength testing results, where water absorption of up to 20 wt. % of the total weight of the composition before the water absorption does not negatively affect modulus of rupture, maximum deflection, apparent modulus of elasticity or proportional elastic limit.

The rapid setting, water durable binder composition of the present invention includes a reactive powder of about 10-40 wt. % cement, about 30-75 wt. % β-stucco, and about 5-30 wt. % pozzolanic material, wherein the pozzolanic material preferably includes fly ash with 0.1-30 wt. % calcium oxide, also a plasticizer in an amount equal to about 0.05-3 wt. % of the reactive powder and water. The water durable binder composition's reactive powder may further comprise up to about 3 wt. % hydrated lime and/or hydrated dolomitic lime. The water durable binder composition's reactive powder may have an absence of hydrated lime and/or hydrated dolomitic lime. The water durable binder may also have an absence of triethanolamine. The reactive powder may have less than 1 wt. % silica fume. Typically the water durable binder may have an absence of silica fume. The reactive powder may have less than 1 wt. % α-stucco, or typically an absence of α-stucco.

The fly ash may include 0.1-30 wt. % calcium oxide (also referred to as lime) which may be embedded in its glass structure. Hydrated lime and/or hydrated dolomitic lime (which is not embedded in the fly ash, cement or any other glass structure) is not included in the calcium oxide in the fly ash. Hydrated lime includes calcium hydroxide and hydrated dolomitic lime includes a combination of calcium hydroxide and magnesium hydroxide.

Binder compositions were tested with 27 parts by weight cement, 60 parts by weight β-stucco, and 10 parts by weight pozzolanic material. Good setting times were achieved with 3 different fly ashes having varying levels of lime (CaO) content (6, 16, and 24 wt. % lime content). Faster setting times were obtained with fly ashes having lower lime content.

The process of minimizing delayed ettringite formation in binders includes adding fly ash with up to 30 wt. % calcium oxide to cement and β-stucco to form a reactive powder, adding a plasticizer, mixing with water, preferably in a 0.45-0.70 water:reactive powder weight ratio at a temperature of about 40-120° F., preferably 50-100° F., more preferably 40-90° F., mixing with lightweight fillers, where the lightweight filler:reactive powder weight ratio is about 0.1-1.75, and then applying the resulting aqueous binder composition to form a panel product which will be exposed to water in end use.

The binder composition optionally includes 2-10 wt. % lightweight fillers, preferably lightweight expanded clay, shale, perlite and/or expanded plastic beads, and entrained air, for example 10-50 vol. %, on a wet basis, and optional additives such as water reducing agents, chemical set-accelerators, chemical set-retarders, and crystal nucleating agents, preferably ground gypsum, more preferably, heat resistant accelerators, which are finely ground gypsum, which may be coated with sucrose or dextrose or uncoated. The binder may also optionally contain 0-35 wt. % secondary fillers, for example 10-35 wt. % secondary fillers. Typical secondary fillers include one or more expanded clay, shale aggregate, limestone, expanded plastic beads, hollow glass microspheres, cenospheres, and pumice.

Cementitious products with lightweight density are preferred. Lightweight products of this invention, for example lightweight board or other lightweight compositions, preferably have a density less than 120 pcf (pounds per cubic foot), more preferably less than 90 pcf, and most preferably less than 60 pcf. Obtaining lightweight density is assisted by employing (i) expanded perlite employing special attributes, expanded clay, shale, and/or expanded plastic beads and (ii) air entrainment.

The entrained air represents 10-50% of composite volume on a wet basis. Air-entrainment in the compositions of the invention is provided by means of suitable surfactants that form a stable and uniform structure of air voids in the finished product.

The cementitious binders of the invention typically have one or more of the following advantages:
low delayed ettringite formation,
low water demand,
flowable and workable slurries obtained at low water dosages,
lower temperature slurries,
less expensive raw material components,
lightweight density,
high compressive strength,
excellent water durability,
rapid setting behavior, and
superior aesthetics and appearance.

It is an object of the invention to provide lightweight cement board from the lightweight binder composition on the invention.

It is another object of the invention to provide cementitious compositions and products having a density in the range of about 30 to 120 pcf, more preferably less than 90 pcf, and most preferably less than 60 pcf. The compositions and products being set. The preferred flexural strength of boards made from this composition ranges between 400 to 2500 psi when tested per the ASTM C947 standard.

It is another object of the present invention to provide lightweight cement boards that on a 0.15 to 2 inches, preferably 0.20 to 1.00 inches, most preferably 0.25 to 0.75 inches, thick basis weigh preferably less than 5 pounds per sq.ft., more preferably less than 4 pounds per sq.ft., and most preferably less than 3 pounds per sq.ft., e.g., 0.5-5 pounds per sq.ft., more preferably 0.5-4 pounds per sq.ft., and most preferably 0.5-3 pounds per sq.ft.

It is another object of the present invention to provide cement board panels that are used as durable and bondable substrate for installation of ceramic tiles, dimensional stones, and plaster finishes.

It is another object of the present invention to provide cement board panels that have good water repellency and resistance to water penetration.

It is another object of the present invention to provide cement board products that have good moisture durability and dimensional stability to allow them to be used in wet areas in buildings.

It is another object of the present invention to provide lightweight cement boards that are resistant to bacteria, mold, and fungal growth.

It is another object of the present invention to provide lightweight cement board products that have good freeze-thaw durability.

It is another object of the present invention to provide cement boards that are responsible for development of good bond between the cementitious core and surface reinforcing meshes in thin cement board products during and after manufacturing.

It is another object of the present invention to provide lightweight binder compositions that lead to efficient processing of lightweight cement board products in commercial manufacturing environments.

It is another object of the present invention to provide methods for preparing lightweight binder compositions for manufacturing cement board panels and building products.

Thus, this invention relates generally to rapid setting lightweight binder compositions for construction of panels or boards.

Obtaining the lightweight density is assisted by employing (i) expanded perlite employing special attributes and (ii) air entrainment.

The entrained air typically represents 5-40 volume %, more typically 5-25 volume %, on a wet basis. Air-entrainment in the compositions of the invention is provided by means of suitable surfactants that form a stable and uniform structure of air voids in the finished product.

The lightweight binder compositions of the present invention can be used to make precast concrete products such as cement boards with excellent moisture durability for use in wet and dry locations in buildings. The precast concrete products such as cement boards are made under conditions which provide a rapid setting of the cementitious mixture so that the boards can be handled soon after the cementitious mixture is poured into a stationary or moving form or over a continuously moving belt.

Typically, the board has a thickness of about 0.15 to 2 inches, preferably 0.20 to 1.00 inches, most preferably 0.25 to 0.75 inches. The board may have has at least one of the following properties:

nail pull strength of at least 60 lbs (267 Newtons) per ASTM C1325;

flexural strength of at least 400 psi (2.76 MPa) per ASTM C947; and

shear bond strength to ceramic tile and cement mortar (a ceramic tile is bonded to the board using cement mortar) at least 50 psi (0.34 MPa) per ANSI A118.9.

The invention may also provide a floor system comprising cement boards of the invention, which pass a minimum of first three cycles of the test per ASTM C627 for structural durability.

All percentages, ratios and proportions herein are by weight, unless otherwise specified. Also, any average molecular weights are weight average molecular weight unless specified otherwise.

### BRIEF DESCRIPTION OF THE DRAWINGS

FIG. 1 shows relative delayed ettringite relative area determined by XRD.

FIG. 2 is a photograph of a Gilmore needle test for a set time used in an example of the present specification.

FIG. 3 shows cube compressive strength (psi) results for gypsum-cement mixes with different water:cement ratios.

FIG. 4 shows set time (minutes) for mixes containing different levels of alum.

FIG. 5 shows the flow (inches) of Mix 1, 2 and 3.

FIG. 6 shows the set time (minutes) of Mix 1, 2 and 3.

FIG. 7 shows a testing apparatus for modified penetration resistance tests on foamed slurries in examples of the present specification.

FIGS. 8A and 8B are photographs of the equipment for the lab test for paper peel in examples of the present specification.

FIG. 9 shows penetration resistance (penetration indentation in psi) and the impact of a heat-resistant accelerator.

FIGS. 10A and 10B are photographs of the paper peel lab test at 5 minutes; FIG. 10A is Mix 1 without HRA; FIG. 10B is Mix 2 with 0.63% HRA.

FIG. 11 shows the impact (effect) of different levels of HRA on penetration resistance (psi).

FIG. 12 shows the effect of temperature on penetration resistance.

FIG. 13 shows cube compressive strength vs. cube density.

FIG. 14 shows linear movement in the binder.

FIG. 15 shows water absorption (%) for nail pull samples.

FIG. 16 shows nail pull v. as-is density.

FIGS. 17A-D show flexural strength results, FIG. 17A is Modulus of Rupture (MOR), FIG. 17B is maximum displacement (inches), FIG. 17C is apparent modulus of elasticity (AMOE) (ksi), and FIG. 17D is proportional elastic limit (PEL) (psi).

FIG. 18A, FIG. 18B are photographs of a sample at different magnifications showing a 7 day soaked panel with no ettringite located.

FIG. 19 is a photograph showing 7 day soaked panel with ettringite not easily located.

### DETAILED DESCRIPTION OF THE INVENTION

### Binder

TABLE 1 describes mixtures used to form the binder compositions of the present invention.

TABLE 1
Reactive Powders

| Ingredient (weight % of | | | More | |
|---|---|---|---|---|
| reactive powder) | | Preferably | preferably | Typically |
| Cement | 10-40 | 20-30 | 25-30 | 27 |
| B-stucco (beta calcium | 30-75 | 40-70 | 50-65 | 60 |
| sulfate hemihydrate) | | | | |
| Pozzolanic material | 5-30 | 5-20 | 7-15 | 10 |
| Calcium hydroxide | Less than | 0.5-3 | 1-3 | 3 |
| (“hydrated lime and/or | or equal | | | |
| hydrated dolomitic | to 3 | | | |
| lime”) | | | | |

### Cement

The cement comprises hydraulic cement, including Portland cement, white cement, slag cements such as blast-furnace slag cement, pozzolan blended cements, expansive cements, sulfo-aluminate cements, oil-well cements, preferably Portland cement, more preferably type III Portland cement. ASTM C 150 standard specification for Portland cement defines Portland cement as a hydraulic cement produced by pulverizing clinker consisting essentially of hydraulic calcium silicates, usually containing one or more of the forms of calcium sulfate as an inter-ground addition. More generally, other hydraulic cements may be substituted for Portland cement, for example calcium sulfo-aluminate based cements. To manufacture Portland cement, an intimate mixture of limestone and clay is ignited in a kiln to form Portland cement clinker. The following four main phases of Portland cement are present in the clinker-tricalcium silicate (3CaO·SiO₂, also referred to as C₃S), dicalcium silicate (2CaO·SiO₂, called C₂S), tricalcium aluminate (3CaO·Al₂O₃ or C₃A), and tetracalcium aluminoferrite (4CaO·Al₂O₃·Fe₂O₃ or C₄AF). The resulting clinker containing the above compounds is inter-ground with calcium sulfates to desired fineness to produce the Portland cement.

The other compounds present in minor amounts in Portland cement include double salts of alkaline sulfates, calcium oxide, and magnesium oxide. Of the various recognized classes of Portland cement, ASTM Type III Portland cement is most preferred in the reactive powder of the binder compositions of the invention. This is due to its relatively faster reactivity and high early strength development.

High alumina cement is also commonly referred to as aluminous cement or calcium aluminate cement. As the name implies, high alumina cements have a high alumina content, about 36-42 wt % is typical. Higher purity high alumina cements are also commercially available in which the alumina content can range as high as 80 wt %. These higher purity high alumina cements tend to be very expensive relative to other cements. High alumina cement and high calcium sulfo-aluminate cement may be included but is not preferable due to its expense.

### Perlite

The binder composition may comprise lightweight expanded perlite filler. The expanded perlite filler may be present at about 0.01-0.15 perlite:reactive powder weight ratio.

The expanded perlite filler is optional and may be 2-10 weight %, 7.5-40 volume % of the binder on a wet basis. The expanded perlite filler is composed of particles having a Dp50 by number of particles mean particle diameter typically between 20-500 microns or 20 to 250 microns, preferably between 20-150 microns, more preferably between 20-125 microns, even more preferably between 20-100 microns, and most preferably between 20-75 microns, an effective particle density preferably less than 0.50 g/cc, more preferably less than 0.40 g/cc, for example 0.10-0.40 g/cc, and most preferably less than 0.30 g/cc. The expanded perlite is typically chemically treated with silane, siloxane, silicone coatings or a mixture thereof. These preferred expanded perlite fillers used in this invention are unique in that the individual perlite particles are chemically coated for water-tightness and water repellency.

Furthermore, the coated expanded perlite filler particle size allows formation of an effective-water-tight closed cell particle structure with the applying of the chemical coating. The use of the selected coated expanded perlite filler is important to allowing preparation of workable and processable slurries at low water usage rates. Lower amounts of water in the composition results in a product having superior mechanical properties and physical characteristics. The most preferred chemical coating compounds for making perlite particles water-tight and water repellant are alkyl alkoxy silanes and silicone emulsions comprising mixtures of silanes and/or siloxanes. Octyltriethoxy silane represents the most preferred alkyl alkoxy silane to coat perlite for using with the binder of this invention.

One of the most preferred commercially available chemically coated perlite fillers is SIL-CELL 35-23 available from Silbrico Corporation. SIL-CELL 35-23 perlite particles are chemically coated with alky alkoxy silane compound. Other preferred chemically coated perlite filler are SIL-CELL 35-34, SIL-CELL 32-23, SIL-CELL 42-23, SIL-CELL 43-23, SIL-CELL 50-23, SIL-CELL 32-34, SIL-CELL 35-34, SIL-CELL 43-34, SIL-CELL 43-34, and SIL-CELL 50-34, all available from Silbrico Corporation. SIL-CELL 35-34, SIL-CELL 32-23, SIL-CELL 42-23, SIL-CELL 43-23, SIL-CELL 50-23 particles are coated with a silane coating having a monomer molecular structure, whereas, the SIL-CELL 32-34, SIL-CELL 35-34, SIL-CELL 43-34, SIL-CELL 43-34, and SIL-CELL 50-34 are coated with silicone coating having a polymer molecular structure. DICAPERL 210 and DICAPERL 220 are yet another two commercial coated perlite filler products produced by Grefco Minerals Inc. that are preferred in this invention. DICAPERL 210 perlite, with alkyl alkoxy silane compound is particularly preferred in the binders of the invention. DICAPERL 220 perlite, coated with silicone compound is also useful in the binders of this invention. Another examples of a preferred perlite is MICROSIL 200S from Termolita.

Another very useful property of the perlite fillers of the invention is that they display pozzolanic properties because of their small particle size and silica-based chemical nature. Owing to their pozzolanic behavior, the selected perlite fillers of the invention improve chemical durability of the composites while developing improved interfaces and enhanced bonding in the binders.

Yet another important benefit results from the small size of the perlite filler particles of this invention. This improvement pertains to the manufacturability and performance characteristics of mesh reinforced cement board products produced using the perlite compositions of the invention. Selected perlite fillers of the invention enhance the overall amount of very fine particles (less than 75 microns Dp50 by number of particles) present in the composition. Presence of high content of fine particles in the composition is extremely useful in rapid processing of mesh reinforced cement board as it helps to improve the bond between the binders and reinforcing mesh. Improved bond between binders and reinforcing mesh leads to reduced occurrences of mesh delamination, faster cement board processing speeds, and improved production recoveries.

### B-Stucco (β-Calcium Sulfate Hemihydrate)

β-stucco is used in the present invention. α-stucco (alpha-stucco) and β-stucco (beta-stucco) have the same CaSO₄·½H₂O chemical formula but different in crystal structure. α-stucco is obtained by heating gypsum under high pressure in the presence of steam or water, whereas high pressure is not used to obtain β-stucco. The crystal structure of α-stucco relatively stubby with a lower aspect ratio. Due to its lower surface area, α-stucco requires less water than β-stucco for workability and offers high strength properties. In contrast to α-stucco, β-stucco is more affordable. The crystal structure of β-stucco gypsum is needle-like and has higher surface area than α-stucco.

### Pozzolanic Material

Pozzolanic materials are siliceous or siliceous and aluminous materials which in themselves possess little or no cementitious value, but will, in finely divided form and in the presence of moisture, chemically react with calcium hydroxide at ordinary temperatures to form compounds possessing cementitious properties. Various natural and man-made materials have been referred to as pozzolanic materials possessing pozzolanic properties. Some examples of pozzolanic materials include pumice, diatomaceous earth, silica fume, tuff, trass, rice husk, metakaolin, ground granulated blast furnace slag, and fly ash. The pozzolanic material comprises fly ash alone or with additional pozzolanic material as part of the reactive powder of the invention. All of these additional pozzolanic materials can be used together with the fly ash either singly or in combined form as part of the reactive powder of the invention. In certain embodiments, silica fume is excluded from the binder.

Silica fume is finely divided amorphous silica which is a by-product of silicon metal and ferro-silicon alloy manufacture. Silica fume, also known as microsilica, (CAS number 69012-64-2, EINECS number 273-761-1) is an amorphous (non-crystalline) polymorph of silicon dioxide, silica. It is typically an ultrafine powder and consists of smooth glassy spherical particles of amorphous SiO₂. Typically silica fume is at least 80 wt % amorphous. Page 8 the “Silica Fume User's Manual”, FHWA-IF 05 016, Silica Fume Association and US Dept. of Transportation/Federal Highway Administration (April 2005) provides a definition of “amorphous”.

Silica fume is sometimes confused with fumed silica (also known as pyrogenic silica, CAS number 112945-52-5). However, the production process, particle characteristics and fields of application of fumed silica are all different from those of silica fume.

Also, silica flours and silica fume are different materials with different characteristics. Silica flours are small angular, irregular particles of crystalline silica sand. Silica flour is a very finely divided, highly purified form of crystalline silica that consists of particles of up to 100 μm in diameter. Nanosize particles (10-100 nm) may be present in some preparations. Silica flours are not pozzolanic material. The “Silica Fume User's Manual”, FHWA-IF 05 016, Silica Fume Association and US Dept. of Transportation/Federal Highway Administration (April 2005) also discloses silica flour is not a pozzolan. At the bottom of Page 3 is the description for silica flour, “Silica flour and silica dust-caution: these materials are a crystalline form of silica that will not perform like silica fume in concrete”.

Fly ash is the preferred pozzolan in the binders of the invention. Fly ashes containing low calcium oxide content (such as Class F fly ashes of ASTM C618-22 standard) are preferred as explained below.

Fly ash is a fine powder byproduct formed from the combustion of coal. Electric power plant utility boilers burning pulverized coal produce most commercially available fly ashes. These fly ashes consist mainly of glassy spherical particles as well as residues of hematite and magnetite, char, and some crystalline phases formed during cooling. The structure, composition and properties of fly ash particles depend upon the structure and composition of the coal and the combustion processes by which fly ash is formed. ASTM C618 standard recognizes two major classes of fly ashes—Class C and Class F.

These two classes of fly ashes are derived from different kinds of coals that are a result of differences in the coal formation processes occurring over geological time periods. Class F fly ashes are normally produced from burning anthracite or bituminous coal, whereas Class C fly ashes are normally produced from lignite or sub-bituminous coal.

The ASTM C618-22 standard differentiates Class F and Class C fly ashes primarily according to their pozzolanic properties. Accordingly, in the ASTM C618-22 standard, the major specification difference between the Class F fly ash and Class C fly ash is the amount of lime or calcium oxide (CaO) in the composition. Class F fly ashes have a maximum lime content of less than 18 wt. %, whereas Class C fly ashes have a lime content of greater than 18 wt. %. Class F fly ashes tend to be more pozzolanic than the Class C fly ashes.

The fly ash comprises Class F fly ash, Class C fly ash, or mixtures thereof, with up to 30 wt. % calcium oxide, which is incorporated in the glass structure on the fly ash particles. Preferably, the fly ash is a Class F fly ash comprising preferably up to 24 wt %, up to 18 wt. %, up to 16 wt. %, up to 10 wt. %, up to 6 wt. %, or up to 1 wt. %, most preferably 1-30 wt %, 1 to 18 wt. %, 1 to 16 wt. %, 1 to 10 wt. %, or 1 to 6 wt. % calcium oxide. If desired the fly ash is a Class F fly ash comprising 4-18 wt. %, 4-16 wt. %, 4 to 10 wt. %, or 4 to 6 wt. % calcium oxide.

The pozzolanic material in compositions and methods of the invention may be at least 50 wt % fly ash, typically at least 70 wt % fly ash, more typically at least 90 wt. % fly ash, for example, 100% fly ash.

### Hydrated Lime and/or Hydrated Dolomitic Lime

Hydrated lime, Ca(OH)₂ and/or hydrated dolomitic lime, Ca(OH)₂—Mg(OH)₂ may be added to the binder composition. This hydrated lime and/or hydrated dolomitic lime is in addition to any bound lime (CaO) in fly ash or cement. Hydrated lime and/or hydrated dolomitic lime is not embedded in a glass structure of a pozzolanic material such as fly ash or the lime embedded in hydraulic cement. The reactive powder may have an absence of hydrated lime and/or hydrated dolomitic lime.

### Plasticizer

Plasticizers, also known as superplasticizers, may be included in the binder compositions of the invention and added in the dry form or in the form of a solution. Plasticizers help to enhance workability and reduce the water demand of the aqueous mixture. Examples of plasticizers include polycarboxylate ethers (“PCE”), polyacrylates, polycarboxylates, lignosulfonates, melamine sulfonates, and the like. Naphthalene sulfonates may be excluded from the binders of the present invention.

The plasticizer is present in an amount equal to about 0.05-3 wt. % of the reactive powder, preferably about 2 wt. % or less, preferably about 0.1 to 1.0 wt. %, more preferably about 0.05 to 0.80 wt. %, even more preferably 0.10 to 0.60%, and most preferably about 0.15 to 0.40 wt. %.

The plasticizer may include polycarboxylate ether (“PCE”) plasticizers, for example BASF's LVR Flow 16. U.S. Pat. No. 7,767,019 to Liu et al., incorporated by reference, discloses embodiments of branched polycarboxylates suitable for use as dispersants for the present gypsum slurries. U.S. Pat. No. 10,442,732 to Vilinska et al., incorporated by reference, discloses examples of linear polycarboxylate dispersants. Plasticizers used in this invention typically do not include naphthalene sulfonate based plasticizers. The plasticizer is added to enhance workability and reduce the water demand of the binder.

Other Chemical Additives and Ingredients

Aluminum sulfate may be present in the binder composition in an amount equal to 0-1 wt. % of the reactive powder, preferably 0-0.5 wt. % and most preferably 0.01-0.10 wt. %.

Mineral-based nucleating agents (referred to also as “nucleating agents”) such as finely ground gypsum (with or without chemical treatment) may be present in the binder composition of the invention. Finely ground gypsum nucleating agents, also termed here as heat-resistant accelerators (HRAs), may be present in the binder composition and comprise for example a gypsum powder finely interground with dextrose. In the binder composition of this invention, the heat-resistant accelerator (HRA) may be present in an amount equal to 0.1-1.5 wt. %, preferably 0.3-1.2 wt. %, most preferably 0.5-1.1 wt. % of the reactive powder.

Examples of heat-resistant accelerator (HRA) include finely ground gypsum coated with dextrose and/or sucrose or simply uncoated ground gypsum. An example is further described in U.S. Pat. No. 2,078,199, herein incorporated by reference.

Mineral-based nucleating agents such as finely ground gypsum are crucial to some embodiments of the present invention as they allow rapid setting action and strength development of cementitious mixture to enable rapid production of building products on a production line.

### Retarders

Use of set retarders as a component in the compositions of the invention is particularly helpful in situations where mixture utilizes lower water amount, or where longer mixing times are involved, or in scenarios where the initial slurry temperature used to form the cement-based products is particularly high, typically greater than 100° F. (38° C.). In these conditions, set retarders such as sodium citrate, citric acid, gluconic acid, or DTPA (diethylenetriamine pentaacetate) promote synergistic physical interaction and chemical reaction between different reactive components in the compositions resulting in favorable slurry workability and superior slurry temperature rise response and rapid setting behavior. Without the addition of retarders, stiffening of the reactive powder blend of the invention may occur very rapidly, soon after water is added to the mixture. Rapid stiffening of the mixture is undesirable because it contributes to poor workability and material consolidation, inferior product manufacturability, and lower product strength.

The primary function of a retarder in the composition is to keep the slurry mixture from stiffening too rapidly thereby promoting synergistic physical interaction and chemical reaction between the different reactive components. Other secondary benefits derived from the addition of retarder in the composition include reduction in the amount of plasticizer and/or water required to achieve a slurry mixture of workable consistency. All of the aforementioned benefits are achieved due to suppression of false setting. Examples of some useful set retarders include sodium citrate, citric acid, potassium tartrate, sodium tartrate, and the like. In the compositions of the invention, sodium citrate is the preferred set retarder. Furthermore, since set retarders prevent the slurry mixture from stiffening too rapidly, their addition plays an important role and is instrumental with respect to product manufacturability in commercial production environments.

Retarders may be present in the binder composition and comprise sodium citrate, citric acid, potassium tartrate, sodium tartrate or mixtures thereof. The retarders may be present in an amount equal to 0.01-1.5 wt. % of the reactive powder, preferably less than 1.0 wt. %, and most preferably less than 0.50 wt. %.

### Alkanolamines

Alkanolamines are amino alcohols that are strongly alkaline and cation active. Examples include triethanolamine [N(CH₂—CH₂OH)₃], monoethanolamine [NH₂(CH₂—CH₂OH)], diethanolamine [NH(CH₂—CH₂OH)₂]. In certain embodiments of the invention, the binder composition excludes alkanolamines. In certain embodiments, the binder excludes triethanolamine (“TEA”).

Other additives including shrinkage control agents, slurry viscosity modifying agents (thickeners), coloring agents and internal curing agents, may be included as desired depending upon the processability and application of the binder composition of the invention.

### Slurry

The binder composition of the present invention is mixed with water to form a slurry. The water:reactive powder weight ratio is 0.40-0.70, preferably 0.45, 0.50, 0.55, 0.60, 0.62, or 0.70.

### Air-Entraining Agents (Foaming Agents)

When it is desired to produce the present lightweight products such as lightweight cement boards, air-entraining agents (foaming agents) may be added in the composition to lighten the product. Air-entrainment agents are generally suitable surfactants that form a stable and uniform structure of air voids in the finished product. Accordingly the slurry contains a suitable air entrainment or foaming agent in such amounts to produce the desired degree of air entrainment.

Typically air entraining agents or foaming agents are surfactants, provided in an amount from about 0.0015 to 0.03 wt. %, based upon the total slurry weight. More preferably, the weight of these surfactants ranges between 0.002 to 0.02 wt. %, based upon the total slurry weight. For example, sodium alkyl ether sulfate, ammonium alkyl ether sulfate, sodium alpha olefin sulfonate (AOS), sodium deceth sulfate, ammonium deceth sulfate, sodium laureth sulfate, or sodium dodecylbenzene sulfonate are suitable air entraining and foaming surfactants that can be used in the compositions of the invention.

In the compositions of the invention, externally produced foam is preferably used to reduce slurry and product density. The foam is prepared using suitable surfactants (foaming agents) together with water and air in proper proportions combined in foam generation equipment. The foam so produced is then introduced directly in to the wet mixture during the mixing operation while preparing slurry.

Entrained air may be 5-50 vol. % of the binder composition, preferably 10-45 vol. %, most preferably 20-40 vol. %.

### Phosphates

If desired, ammonium or metal phosphates may optionally be used in the present invention. Such metal phosphates may be one or more of sodium trimetaphosphate (STMP), potassium tripolyphosphate (KTPP) and sodium tripolyphosphate (STPP). These phosphates help to strengthen the composition microstructure and increase the strength to density ratio of the final manufactured product.

Ammonium or metal phosphate is in the composition in an amount equal to 0 to 1.5 wt. %, or 0.15 to 1.5 wt. %, or about 0.3 to 1.0 wt. %, or about 0.5 to 0.75 wt. % of the reactive powder. Thus, for example, for 100 pounds of reactive powder, there may be about 0 to 1.5 pounds of the ammonium or metal phosphate.

### Inorganic Secondary Set Accelerators

In combination with the above-discussed alkanolamines and optional metal phosphates, other inorganic set accelerators may be added as inorganic secondary set accelerators in the binder composition of the invention.

Addition of these inorganic secondary set accelerators is expected to impart only a small reduction in setting time in comparison to the reduction achieved due to the addition of the combination of alkanolamines and optional metal phosphates. Examples of such inorganic secondary set accelerators include a sodium carbonate, potassium carbonate, potassium sulfate, calcium nitrate, calcium nitrite, calcium formate, calcium acetate, calcium chloride, lithium carbonate, lithium nitrate, lithium nitrite, aluminum sulfate and the like. The use of calcium chloride should be avoided when corrosion of cement board fasteners is of concern.

The weight ratio of the secondary inorganic set accelerator to the reactive powder typically will be less than 2 wt %, preferably about 0.0 to 1 wt %. In other words, for 100 pounds of reactive powder there is typically less than 2 pounds, preferably about 0.0 to 1 pounds, of secondary inorganic set accelerator. These secondary set accelerators can be used alone or in combination.

### Lightweight Fillers and Scrims

It will be understood by those skilled in the art that other materials may be included in the composition depending on its intended use and application.

For instance, for cement board applications, it is desirable to produce lightweight boards without unduly comprising the desired mechanical properties of the product. This objective is achieved by adding lightweight fillers. Examples of useful lightweight fillers include blast furnace slag, volcanic tuff, pumice, expanded forms of clay, shale, hollow ceramic spheres, hollow plastic spheres, expanded plastic beads, vermiculite, slate, scoria, expanded slag, cinders, glass microspheres, synthetic ceramic microspheres, hollow ceramic microspheres, lightweight polystyrene beads and the like. For producing cement boards, expanded clay and shale aggregates are particularly useful. Expanded plastic beads and hollow plastic spheres when used in the composition are employed in very small quantity on weight basis owing to their extremely low bulk density.

Lightweight fillers typically have a specific gravity of less than about 1.75, preferably less than about 1, more preferably less than about 0.75, and still more preferably less than about 0.5. In some other preferred embodiments of the invention the specific gravity of lightweight fillers is less than about 0.35, more preferably less than about 0.25 and most preferably less than about 0.1. In contrast, inorganic mineral filler preferably has a specific gravity above about 2.0.

Pumice used as lightweight filler is a hydrated aggregate (filler) and not cement. In contrast, pumice used as pozzolanic mineral additive (describe in the above-listed section entitled “Mineral Additives”) is a non-hydrated form and falls within the ASTM C618-97 definition of pozzolanic materials as “siliceous or siliceous and aluminous materials which in themselves possess little or no cementitious value, but will, in finely divided form and in the presence of moisture, chemically react with calcium hydroxide at ordinary temperatures to form compounds possessing cementitious properties.”

Depending on the choice of lightweight filler selected, the weight ratio of the lightweight filler to the reactive powder blend may be about 1/100 to 200/100, preferably about 2/100 to 125/100. For example, for making lightweight cement boards, the weight ratio of the lightweight filler to the reactive powder blend may be about 2/100 to 125/100.

However, as mentioned above, preferably the total of expanded and chemically coated perlite filler and secondary fillers, for example expanded clay, shale aggregate and/or pumice, is in an amount equal to at least 20% wt. of the reactive powder.

Moisture content of a lightweight fillers adversely affects the setting time of the binders. Thus, fillers having low water content are preferred in the present invention.

Discrete reinforcing fibers of different types may also be included in the binders of the invention. Scrims made of materials such as polymer-coated glass fibers and polymeric materials such as polypropylene, polyethylene and nylon may be used to reinforce the binder depending upon its function and application.

TABLE 2 lists typical additive ranges in accordance with this invention.

TABLE 2
Additive ranges (in an amount equal
to weight % of reactive powder)

| | Preferred | More preferred | Most preferred |
|---|---|---|---|
| Nucleating Agent (HRA) | 0.1-1.5 | 0.2-1.2 | 0.3-1.1 |
| Plasticizer (preferably PCE) | 0.1-1 | 0.15-0.75 | 0.2-0.5 |
| Aluminum sulfate (“Alum”) | 0-1 | 0-0.5 | 0-0.1 |
| Retarder | 0-1 | 0-0.5 | 0-0.1 |

TABLE 3 lists formulation ranges in accordance to this invention.

TABLE 3
Formulation ranges

| | |
|---|---|
| water/reactive powder weight ratio | 0.40-0.70 |
| Lightweight filler/reactive powder weight ratio | 0.01-1.75 |
| *Expanded Perlite/reactive powder weight ratio | 0.05-0.15 |
| Portland cement (wt % of reactive powder) | 20-40 |
| β-Stucco weight (wt % of reactive powder) | 30-75 |
| Fly ash weight (wt % of reactive powder) | 5-30 |

*Expanded perlite/reactive powder weight ratio is a subset of lightweight filler/reactive powder weight ratio.

### Process

The invention provides a process of minimizing delayed ettringite formation in a binder composition comprising:

adding pozzolanic material which comprises fly ash to a mixture of cement and β-stucco to make a reactive powder,

adding plasticizer to the reactive powder,

adding water and one or more lightweight fillers to the mixture, preferably in a 1:0.40-0.70 reactive powder:water weight ratio, at 40-120° F., preferably 45-100° F., more preferably 50-90° F., with a lightweight filler:reactive powder weight ratio of 0.01-1.75,

applying the mixed binder and water to form a board product which will be exposed to water in end use.

The process of minimizing or reducing the delayed ettringite (also known as secondary ettringite formation) of the present invention is more economical than prior art processes and minimizes or reduces delayed ettringite formation. The water:reactive powder weight ratio is 0.45-0.70, preferably 0.5, 0.55, 0.60. The lightweight filler:reactive powder weight ratio is 0.01 to 1.75, preferably 0.1 to 1.0, more preferably 0.02, 0.05, 0.10, 0.15, 0.40, 0.40, 0.50, 0.60, 0.70.

### Manufacturing of Precast Concrete Products Such as Cement Boards

Precast concrete products such as cement boards are manufactured most efficiently in a continuous process in which the reactive powder blend is blended with lightweight fillers and other ingredients, followed by addition of water and other chemical additives just prior to placing the mixture in a mold or over a continuous casting and forming belt.

Due to the rapid setting characteristics of the binder composition the mixing of dry components of the binder composition with water usually will be done just prior to the casting operation. As a consequence of the hydration of beta calcium sulfate hemihydrate and the associated water consumption in substantial quantities, the cement-based product becomes rigid, and ready to be cut, handled and stacked for further curing.

Thus, the binder composition of the invention is combined with a suitable amount of water to hydrate the reactive powder and to rapidly form gypsum or calcium sulfate dihydrate. Generally, the amount of water added will be greater than theoretically required for the hydration of the reactive powder. This increased water demand is allowed to facilitate the workability of the cementitious slurry. Typically, the weight ratio of the reactive powder to water is about 100:40-70. The amount of water depends on the needs of the individual materials present in the composition.

Gypsum or calcium sulfate dihydrate form very rapidly in the hydration process thus imparting rapid set and rigidity to the mixtures made with the binder composition of the invention. In manufacturing of cement-based products such as cement boards, it is primarily the rapid hydration of beta calcium sulfate hemihydrate or β-stucco, which makes possible handling of cement boards within a few minutes after the cementitious composition of the invention is mixed with a suitable amount of water.

Setting of the composition is characterized by initial and final set times, as measured using Gilmore needles specified in the ASTM C266 test procedure, as well as high initial compressive strength. The final set time also corresponds to the time when a cement-based product e.g. a cement board, has sufficiently hardened so that it can be handled. It will be understood by those skilled in the art that curing reactions continue for extended periods after the final setting time has been reached.

The slurry in the present invention surprisingly has a relatively low temperature around room temperature. The initial slurry temperature should be at least about 40° F. (4.4° C.) and produces rapid setting times.

It is well known that gypsum and other sulfate compounds react with calcium aluminate in Portland cement to form ettringite within the first few hours after mixing with water. This early ettringite formation (also referred to as primary ettringite) is not harmful as the mixture is still in plastic state. In fact it may play an important role by allowing fast initial set and fast production speed. In the context of this invention, delayed development of ettringite (also referred to as secondary ettringite) in hardened (set) material occurs because of the presence of excessive amounts of sulfate and prolonged exposure to water. This further formation of ettringite after the matrix solidifies (hardens) is detrimental as its destructive expansion results in cement cracking and loss of strength. Silica fume and metakaolin has been shown to significantly reduce expansion due to delayed ettringite formation (U.S. Pat. No. 6,241,815).

The invention advantageously preferably minimizes or reduces the delayed ettringite in the context of the fly ash containing compositions of the present invention to prevent at least some delayed ettringite formation to have the same or less delayed ettringite formation than a mixture that is the same but containing silica fume in place of fly ash.

Minimizing or reducing the delayed ettringite in the context of the present invention may mean preventing at least some delayed ettringite formation to have minimal or small delayed ettringite formation relative to the mixture itself before water exposure.

### Example 1

Binder samples were prepared in the lab with silica fume and the four fly ashes for XRD analysis of delayed ettringite, see Table 4. The water/reactive powder ratio was 0.70, and 0.3% naphthalene sulfonate based plasticizer was added. Mix 1 with silica fume was the control mix. As described previously in this specification, silica fume is finely divided amorphous (non-crystalline) polymorph of silicon dioxide, silica which is the by-product of silicon metal and ferro-silicon alloy manufacture. Mixes 2-5 were with the four fly ashes. All other variables were kept the same for all mixes. The samples were manually mixed at room temperature until uniform, then poured into a thin layer in a large disk. The paste samples were moist-cured at 130° F. (54.4° C.) for 7 days (7 d dry). Part of the samples were then soaked in water for 1, 7, or 14 days. After the samples reached 7 d dry or 7 d dry plus soaking, they were put in acetone-methanol mix (volume ratio 1:1) for 7 days. Hydration was quenched by putting the samples in 1:1 acetone and methanol solution (by volume) for 7 days. The material was dried at 45° C. for 12-24 hours. It was then manually ground with a mortar and pestle and pass 60 or finer mesh. The ground powder was pressed into a zero background XRD holder until it is leveled off. Afterwards the specimens were examined for ettringite by semi-quantitative XRD. The samples were all tested on the same XRD equipment. The samples were run on a Rigaku Ultima IV XRD from 2-72 degrees at 0.02 step interval with a scan time of 2 seconds. Scans are analyzed using JADE for XRD software and the ICDD PDF database.

TABLE 4 shows Binder samples with various fly ash samples containing 24, 16, 6 or 1 wt. % CaO.

TABLE 4
Binder samples with various fly ash samples (wt. %)

| | Mix 1 | Mix 2 | Mix 3 | Mix 4 | Mix 5 |
|---|---|---|---|---|---|
| Type III Portland cement | 27 | 27 | 27 | 27 | 27 |
| β-stucco | 60 | 60 | 60 | 60 | 60 |
| Hydrated Lime and/or | 3 | 3 | 3 | 3 | 3 |
| hydrated dolomitic lime | | | | | |
| Silica fume | 10 | | | | |
| Fly ash 24% CaO | | 10 | | | |
| Fly ash 16% CaO | | | 10 | | |
| Fly ash 6% CaO | | | | 10 | |
| Fly ash 1% CaO | | | | | 10 |

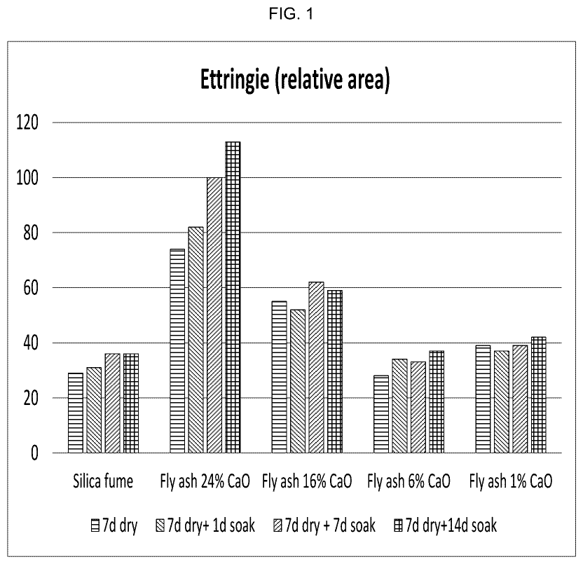

The relative ettringite results for these TABLE 4 samples in FIG. 1 showed that silica fume was the most effective among all materials in suppressing delayed ettringite formation. Delayed ettringite formation after water exposure was insignificant when compared to the 7 days dry result. Fly ash with 24% lime had more than double ettringite of the silica fume mix for 7 day dry sample. Delayed ettringite formation was indicated when there was higher ettringite for longer water exposure. Fly ash with 16% lime showed less ettringite than those for 24% lime fly ash, but still about 1.5-2 times of the silica fume mix. This invention shows that low lime fly ash is more beneficial in suppressing delayed ettringite formation. Fly ash with 6% lime showed excellent pozzolanic reactivity, with only slightly higher ettringite than control mix containing silica fume. Fly ash with 1% lime demonstrated similar excellent pozzolanic reactivity as the Mix 4 containing 6% lime. While lower lime content led to higher pozzolanic reactivity, fly ashes with lime content lower than 10% provided similar pozzolanic reactivity. Low lime fly ash, which is more economical than silica fume, was very effective in reducing delayed ettringite formation.

TABLE 4A compares the areas of the ettringite peaks determined by X-Ray Diffraction (XRD) for samples of Mix 1 with silica fume as the control mix, and Mixes 2-5 were with the four fly ashes. FIG. 1 compares the areas of the ettringite peaks of TABLE 4A. The peaks were determined by X-Ray Diffraction (XRD) for samples of Mix 1 with silica fume as the control mix, and Mixes 2-5 were with the four fly ashes. TABLE 4A and FIG. 1 compare the samples that were moist-cured at 130° F. (54.4° C.) for 7 days (7 d dry). Part of the samples were then soaked in water for 1, 7, or 14 days. All the samples of this specification were tested with the same XRD machine.

TABLE 4A
Relative Ettringite Area

| | | 7 d dry + | 7 d dry + | 7 d dry + |
|---|---|---|---|---|
| Mix | 7 d dry | 1 d soak | 7 d soak | 14 d soak |
| 1 | 29 | 31 | 36 | 36 |
| 2 | 74 | 82 | 100 | 113 |
| 3 | 55 | 52 | 62 | 59 |
| 4 | 28 | 34 | 33 | 37 |
| 5 | 39 | 37 | 39 | 42 |

The ratio of the ettringite XRD peak area measured for a first sample to the ettringite XRD peak area measured for a second sample, when both samples were tested with the same XRD machine, indicated the relative amount of ettringite of the first sample compared to the second sample. The absolute value of an ettringite XRD peak area for a sample of a particular composition measured on different XRD machines may be the same or different. However, the percentage difference between ettringite XRD peak areas of samples should be the same when comparing the samples on the same XRD machine regardless of the XRD machine employed. Also, the ettringite XRD peak area ratio, and thus the weight ratio, between samples tested on the same XRD machine should be the same regardless of the XRD machine employed.

Minimizing or reducing the delayed ettringite of the present invention may be shown when the relative ettringite XRD peak area after 7 day dry+7 day soak (water exposure) and, preferably also 7 day dry+14 d soak, is less than, equal to, or at most 10 greater than the relative ettringite XRD peak area compared to the (without water exposure) value at 7 day dry. This assumes comparing XRD peak areas of ettringite of samples tested on the same XRD machine.

Preferably minimizing or reducing the delayed ettringite of the present invention is shown when the ratio of (1) the difference in XRD peak areas of ettringite after 7 day dry+14 day soak (water exposure) and after 7 day dry (without water exposure) for a composition which is the same as the composition of the invention except for including silica fume as the only pozzolan to (2) the difference in XRD peak areas of ettringite after 7 day dry+14 day soak (water exposure) and ettringite after 7 d dry (without water exposure) for the composition of the invention is 1:0-1.50. This compares a composition of the invention to a composition which is the same but substitutes the fly ash and all other pozzolanic material with an equal amount of silica fume. For example, an inventive sample having 10 pbw total pozzolan, that was 5 pbw fly ash and 5 pbw another pozzolan, would be compared to a silica fume containing composition having 10 pbw silica fume as the pozzolanic material.

If the silica fume-containing composition has a difference of 0 then the % Difference between 7 days dry+14 days soak and 7 days dry ettringite XRD peak areas is preferably an increase of less than 30%, more preferably less than 20%. If both compositions have differences of 0 then the ratio is deemed 1:1.

This comparison assumes comparing XRD peak areas of ettringite of samples tested on the same XRD machine. This comparison also assumes the silica fume meets the requirements of Tables 1 and 2 of the ASTM C1240-20 Standard Specification for Silica Fume Used in Cementitious Mixture, ASTM International (2020) with the exception that SiO2>70 wt. %. ASTM C1240-20 Table 1 says 85 (minimum) wt. %. Thus, the silica fume used in the examples had the following properties of Table 4B:

TABLE 4B
Silica Fume Properties

| | | |
|---|---|---|
| SiO₂ | >70 | wt. % |
| Moisture content, maximum wt. % | 3 | wt. % |
| Loss on ignition (LOI), maximum wt. % | 6 | wt. % |
| Retained on 325 sieve (45 um), maximum | 10 | wt. % |
| Retained on 325 sieve (45 um), max | 5 | wt. % |
| variation from average, percentage points | | |
| BET (Brunauer-Emmett-Teller) specific | 15 | m2/g |
| surface area, minimum | | |

Typically SiO₂ is 85 wt % (minimum). Typically BET is for example 15-30 m²/g. As a hypothetical illustration of Retained on 325 sieve (45 μm), max variation from average, percentage points 5 wt. %, if individual tests constituted an average retained of 8 wt. % the individual tests are between 3 and 13 wt. % retained.

Changing from one silica fume that meets the requirements of Table 4B, summarizing Tables 1 and 2 of the ASTM C1240-20 Standard Specification for Silica Fume Used in Cementitious Mixture, ASTM International (2020) (incorporated herein by reference) with the exception that SiO2>70 wt. %. ASTM C1240-20 Table 1 says 85 (minimum) wt. %, to another silica fume having these properties in a silica fume containing sample does not significantly affect the ettringite XRD peak area.

In FIG. 1, the first mixture contained silica fume (the most reactive pozzolanic material) was the best in suppressing delayed ettringite formation. The mixture containing 24% CaO showed increased ettringite amount with more water exposure when compared to the 7 d dry (without water exposure) result, indicating that delayed ettringite formation was not minimized or reduced. 7 d dry means the sample was hardened to final set (final set is described elsewhere in this specification), then moist cured with wet towels covering the samples at elevated temperature of 130° F. for 7 days without further exposure to liquid water (designated as 7 day dry due to lack of water soaking). After this 7 day moist curing, the samples were soaked in room temperature water for 1, 7, or 14 days (labeled as 7 d dry+1 d soak, 7 d dry+7 d soak, and 7 d dry+14 d soak). The comparison of the ettringite values before and after water soaking was a good indication of delayed ettringite formation.

TABLE 4C compares ettringite XRD peak values shown on FIG. 1 for samples after 7 days dry and 7 days dry+14 days soak.

TABLE 4C

| | | | | | | Ratio of the Difference |
|---|---|---|---|---|---|---|
| | | 7 days dry + | Area Difference between | % | | between 7 d dry and 7 d |
| | 7 days | 14 days soak | 7 days dry + 14 days | Difference between 7 days | Ratio of ettringite | dry + 14 d soak ettringite |
| | dry XRD | ettringite | soak and 7 days dry | dry + 14 days soak and 7 | XRD peak areas at 7 | XRD peak areas for silica |
| | ettringite peak | XRD peak | ettringite XRD peak | days dry ettringite XRD | days dry and 7 days | fume samples and fly ash |
| Sample | area | area | areas | peakareas | dry + 14 days soak | samples (normalized ratio) |
| silica fume | 29 | 36 | 7 | 24% | 1:1.24 | — |
| Fly Ash | 74 | 113 | 39 | 53% | 1:1.53 | 7:39 (1:5.6) |
| 24% CaO | | | | | | |
| Fly Ash | 55 | 59 | 4 | 7% | 1:1.07 | 7:4 (1:0.6) |
| 16% CaO | | | | | | |
| Fly Ash | 28 | 37 | 9 | 32% | 1:32 | 7:9 (1:1.3) |
| 6% CaO | | | | | | |
| Fly Ash | 39 | 42 | 3 | 8% | 1:1.08 | 7:3 (1:0.4) |
| 1% CaO | | | | | | |

The mixture containing Fly Ash 24% CaO had area values that were 2.6 times and 3 times for 7 d dry+7 d soak and 7 d dry+14 d soak, respectively, of the area values for silica fume after the same exposure. The mixture containing Fly Ash 16% CaO showed an improvement to the mixture containing Fly Ash 24% CaO. The ettringite result for Fly Ash 16% CaO 7 d dry was about 55, thus lower than the 74 ettringite result for Fly Ash 24% CaO by about 20. After water soaking of 1-14 days, the Fly Ash 16% CaO ettringite amount was about 59, not drastically higher than the 7 d dry value, and significantly lower than those numbers for the mixture containing Fly Ash 24% CaO. When comparing to the mixture containing silica fume, these numbers are about 1.5-2 times of their counterparts, showing performance inferior to that of silica fume.

The mixtures containing 6% CaO, or 1% CaO showed similar or only slightly higher ettringite amount after water exposure when compared to 7 d dry (without water exposure) value. They were also similar to the mixture containing silica fume, suggesting that delayed ettringite formation was minimized or reduced.

In FIG. 1, the mixture containing silica fume without exposure to water (7 d dry) had a relative area of ettringite (ettringite XRD peak area) of 29. In FIG. 1, the mixture containing silica fume after prolonged exposure to water (7 d dry+14 d soak) had a relative area of ettringite of 36. This is an increase in relative area of ettringite of about 7 which is an increase of about 24 wt. % representing the delayed ettringite. Also, the weight ratio of the amount of ettringite in the silica fume sample at 7 days dry to the amount of ettringite in the silica fume sample at 7 days dry+14 days soak was 1:1.24.

In FIG. 1, the mixture containing Fly Ash 24% CaO without exposure to water (7 d dry) had a relative area of ettringite of 74, about 2.5 times of the mixture containing silica fume without exposure to water (7 d dry). In FIG. 1, the mixture containing Fly Ash 24% CaO, after prolonged exposure to water (7 d dry+14 d soak), increased in relative area of ettringite by 39 to a relative area of ettringite of about 113. This increase represents the formation of delayed ettringite. Thus, the Fly Ash 24% CaO sample at 7 days dry+14 days soak had about 53% more ettringite than at 7 days dry. Also, the area ratio of the amount of ettringite in the Fly Ash 24% CaO sample at 7 days dry to the amount of ettringite in the Fly Ash 24% CaO sample at 7 days dry+14 days soak was 1:1.53. This also represents a weight ratio of 1:1.53. The ratio of the difference between 7 d dry and 7 d dry+14 d soak ettringite XRD peak areas for silica fume samples and fly ash samples (normalized ratio) is 7:39. When normalized for the difference for silica fume this ratio is 1:5.6 as listed in TABLE 4B.

### Example 2

In this example, fast setting binders are prepared with lower slurry temperature and in the absence of triethanolamine (TEA), one of the accelerators in the prior art. The lightweight filler/reactive powder and expanded perlite/reactive powder ratios were kept constant for all three formulations.

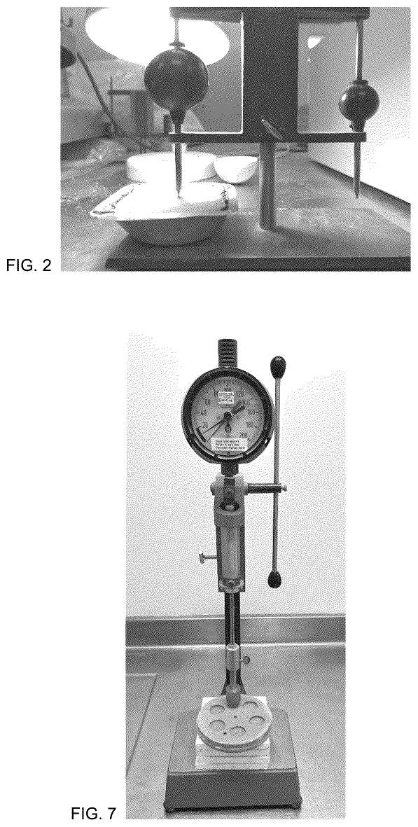

Set time was measured by the Gilmore needle method according to ASTM C266 on un-foamed mixtures poured into a small disk (FIG. 2). Final set time was the time when no mark was left when the needle was slowly lowered to the surface of the mixture.

TABLE 5 lists Mix 1 (control formulation) and Mixes 2-4 and their final set times.

TABLE 5
Fast setting binder compositions

| | Mix 1 | | | |
|---|---|---|---|---|
| | Control | Mix 2 | Mix 3 | Mix 4 |
| Water/Reactive powder Ratio | 0.62 | 0.68 | 0.60 | 0.60 |
| Lightweight filler/Reactive | 0.62 | 0.62 | 0.62 | 0.62 |
| powder Ratio | | | | |
| Expanded perlite/Reactive | 0.065 | 0.065 | 0.065 | 0.065 |
| powder Ratio | | | | |
| Liquids temperature (° C.) | 80 | 50 | 50 | 50 |
| Type III Portland cement parts | 74 | 25 | 25 | 25 |
| β-Stucco parts | | 56 | 56 | 50 |
| Fly ash parts | 15 | 18 | 18 | 25 |
| (16% CaO) | | | | |
| Landplaster parts | 11 | | | |
| Hydrated Lime and/or dolomitic | | 1 | 1 | |
| hydrated lime parts | | | | |
| Total Reactive powder | 100 | 100 | 100 | 100 |
| TEA (% of Reactive powder) | 0.3 | | | |
| Naphthalene sulfonate plasticizer | 0.3 | 0.3 | | |
| (% of Reactive powder) | | | | |
| Polycarboxylate ether plasticizer | | | 0.15 | 0.1 |
| (% of Reactive powder) | | | | |
| Final set time (min) | 7.0 | 7.5 | 7.3 | 7.0 |

In TABLE 5, the control formulation Mix 1 is an example from the U.S. Pat. No. 6,869,474. A water/reactive powder ratio of 0.62 and 0.3% naphthalene sulfonate plasticizer were used to achieve desired workability. A very high liquid temperature of 80° C. (176° F.) was used to achieve an initial slurry temperature of greater than 32.2° C. (90° F.). 0.3% TEA (of reactive powder weight) was used to achieve a very fast final set time of 7.0 minutes.

Mix 2 and Mix 3 were both binder formulations with 25 parts type III Portland cement, 56 parts β-stucco, 18 parts fly ash (16% CaO), and 1 part lime. The liquid temperature was 50° C. because high initial slurry temperature was not needed for fast setting. Mix 2 had a relatively high water/reactive powder ratio of 0.68 when using 0.3% naphthalene sulfonate plasticizer for desired workability. It was seen that a very fast set time of 7.5 minutes was obtained even at the high water/reactive powder ratio. Mix 3 was very similar to mix 2 except that 0.15% polycarboxylate ether plasticizer (PCE) was used. With its high efficiency, a lower water/reactive powder ratio of 0.60 could be used to achieve desired workability. A very fast set time of 7.3 minutes was determined for mix 3. Mix 4 had the same water/reactive powder ratio, lightweight filler/reactive powder ratio, and expanded perlite/reactive powder ratio as mix 3. It had a slightly lower beta stucco content of 50 parts, higher fly ash parts of 25 parts, and no hydrated lime and/or hydrated dolomitic lime. 0.1% PCE plasticizer was used. A very fast set time of 7.0 minutes was obtained for the mixture.

This example shows that a very fast set time could be achieved for binders without an accelerator such as TEA and with a much lower initial slurry temperature. Also PCE based plasticizer (Mixes 3 and 4) allowed a lower water/Reactive powder ratio, which is beneficial to strength development and durability of the binders. Hydrated lime and/or hydrated dolomitic lime is optional and not required to achieve the very fast set time.

### Example 3

In this example, binder formulations of different water/reactive powder ratios were tested for cube compressive strength according to the method in ASTM C109. Cube compressive strength tests were performed on 2″×2″×2″ cube specimens. After mixing the mixtures was poured as fast as possible into the brass cube molds and moisture cured at 65° C. No foaming agent was used to reduce the density. After one day, the specimens were demolded and kept for moisture curing at 65° C. until the time of testing. The cubes were tested 1 day, 2 days, 3 days, and 7 days after casting, and 3 specimens were tested for each age. One set of specimens were soaked in room temperature water for 2 days after they cured for 7 days, and it was labeled 7 d+2 d soak. The strength for soaked specimens is an indication of the water durability of the mixtures.

All mixes had 25 parts type III Portland cement, 50 parts β-stucco, and 25 pts fly ash (with 1% CaO). The lightweight filler/Reactive powder ratio was 0.62, and the expanded perlite/Reactive powder ratio was 0.065 for all mixes. Mix 1-4 had water/Reactive powder ratios of 0.50-0.65. Higher PCE content was used for mixes with lower water/Reactive powder ratios to obtain the desired workability. The details of the mixes are in TABLE 6.

TABLE 6
Binders with different water/Reactive powder ratio

| | Mix 1 | Mix 2 | Mix 3 | Mix 4 |
|---|---|---|---|---|
| Water/Reactive powder Ratio | 0.65 | 0.60 | 0.55 | 0.50 |
| PCE plasticizer | 0.10 | 0.15 | 0.18 | 0.18 |
| (% of Reactive powder) | | | | |

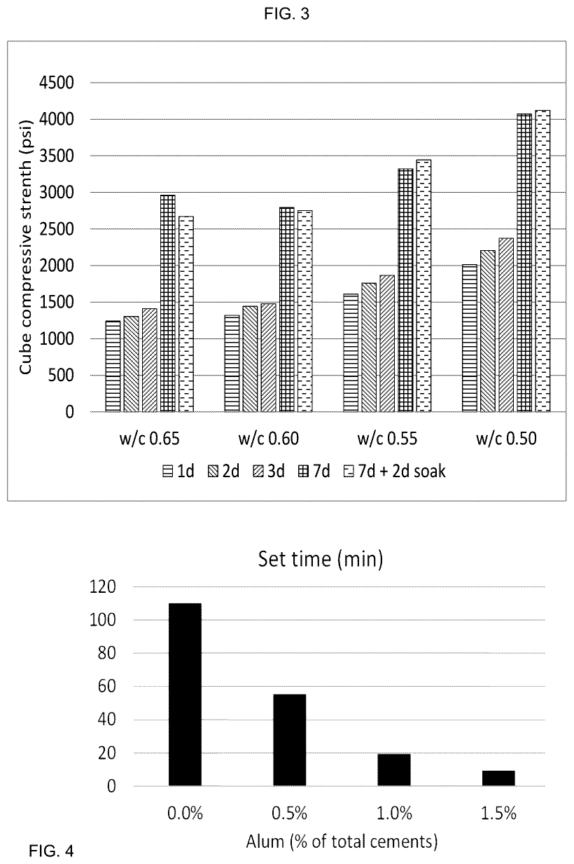

The cube compressive strength results are shown in FIG. 3. It is apparent that strength increased with decreasing water/reactive powder ratio. The soaked strength was lower than 7 days strength for water/reactive powder ratio of 0.65, and stayed about the same for lower water/reactive powder ratios. These results emphasized the importance of lower water/reactive powder ratios, and the criticality of using PCE plasticizers to enable greater water reduction. Naphthalene sulfonated based plasticizers have been shown in the lab not able to reduce water demand to this extent even at higher dosages.

### Example 4

In this example, the effect of aluminum sulfate (alum) was evaluated. Mixes 1-4 all had water/reactive powder ratio of 0.65, lightweight filler/reactive powder ratio of 0.62, and expanded perlite/reactive powder ratio of 0.065. The liquids temperature was 50° C. for all mixes. All mixes had 25 parts type III Portland cement, 50 parts β-stucco, and 25 parts fly ash (with 16% CaO). 0.1% PCE plasticizer was used for all mixes. Mix 1-4 had 0-1.5% alum (weight % of reactive powder). No foaming agent was used to reduce the density.

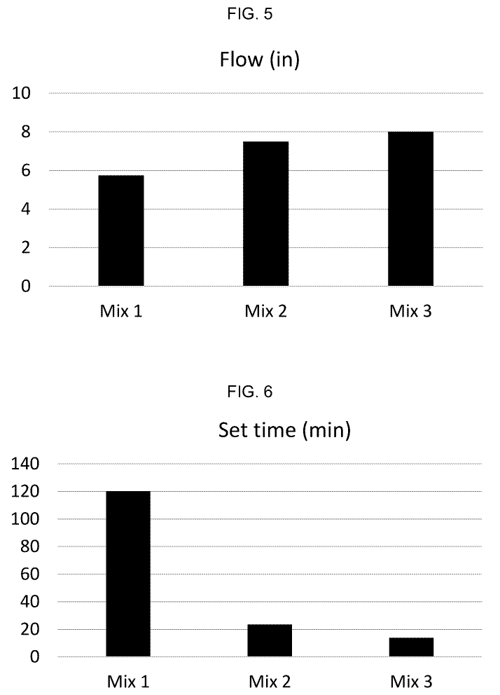

Set time determined by Gilmore needle is shown in FIG. 4. Mix 1 without alum had a very long set time of about 110 minutes. Adding 0.5% alum reduced the set time by half as seen in Mix 2. Adding 1% or 1.5% alum further reduced the set time to 20 and 10 minutes respectively. This example demonstrated the effectiveness of alum in accelerating set time of the binders. TABLE 7 shows the effect of alum on set time.

TABLE 7
Effect of Alum on Set Time

| | Mix 1 | Mix 2 | Mix 3 | Mix 4 |
|---|---|---|---|---|
| Water/Reactive Powder Ratio | 0.65 | 0.65 | 0.65 | 0.65 |
| Lightweight filler/Reactive | 0.62 | 0.62 | 0.62 | 0.62 |
| Powder Ratio | | | | |
| Expanded Perlite/Reactive | 0.065 | 0.065 | 0.065 | 0.065 |
| Powder Ratio | | | | |
| Liquids temperature (° C.) | 50 | 50 | 50 | 50 |
| Type III Portland cement parts | 25 | 25 | 25 | 25 |
| β-stucco parts | 50 | 50 | 50 | 50 |
| Fly ash parts (16% CaO) | 25 | 25 | 25 | 25 |
| Total Reactive powder | 100 | 100 | 100 | 100 |
| Polycarboxylate ether plasticizer | 0.1 | 0.1 | 0.1 | 0.1 |
| (% of Reactive powder) | | | | |
| Alum (% of Reactive powder) | 0 | 0.50 | 1.0 | 1.50.1 |

### Example 5

In this example, the effect of PCE on flow and set time was examined. Flow is a measure of workability. The mixture is poured into a brass cylinder 2 inches in diameter and 4 inches in height. After the slurry fills the cylinder and the material is made flush with the top of the cylinder, the cylinder is lifted to let the mixture flow freely under its own weight. After the mixture stops flowing, the diameter of the mixture spread is measured in inches and reported as workability. The higher the number, the better the workability. The target is 6-7 inches flow.

Mixes 1-3 had the same lightweight filler/reactive powder ratio of 0.62, and expanded perlite/reactive powder ratio of 0.065. All mixes had 25 parts type III Portland cement, 50 parts β-stucco, and 25 parts fly ash (with 1% CaO). Mixes 1-3 had decreasing water/Reactive powder ratio of 0.65-0.55, and increasing levels of PCE plasticizer 0.1-0.175% (by weight of reactive powder). The liquid temperature was 60° C. for all mixes. No foaming agent was used to reduce the density of the mixes. TABLE 8 shows Mixtures with different water/Reactive powder ratios and PCE levels.

TABLE 8
Mixtures with different water/reactive
powder ratios and PCE levels

| | Mix 1 | Mix 2 | Mix 3 |
|---|---|---|---|
| Water/reactive powder Ratio | 0.65 | 0.60 | 0.55 |
| Lightweight filler/reactive | 0.62 | 0.62 | 0.62 |
| powder Ratio | | | |
| Expanded perlite/reactive | 0.065 | 0.065 | 0.065 |
| powder Ratio | | | |
| Liquids temperature (° C.) | 60 | 60 | 60 |
| Type III Portland cement parts | 25 | 25 | 25 |
| β-stucco parts | 50 | 50 | 50 |
| Fly ash parts (1% CaO) | 25 | 25 | 25 |
| reactive powder | 100 | 100 | 100 |
| Polycarboxylate ether plasticizer | 0.1 | 0.15 | 0.175 |
| (% of reactive powder) | | | |

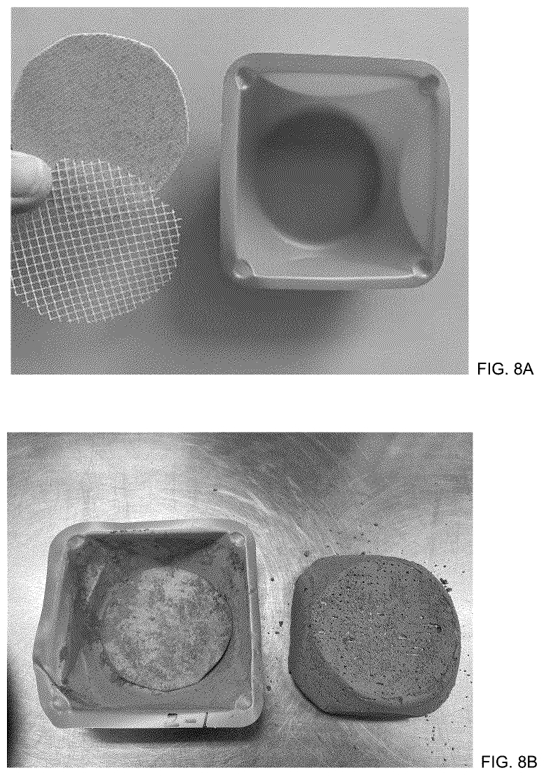

FIG. 5 shows the flow of the three mixes. Mix 1 with high water/reactive powder ratio of 0.65 and low PCE level of 0.1% had 6″ flow, which is good fluidity. Even though mix 2 had lower water/reactive powder ratio of 0.60, the flow was close to 8″ with the higher PCE level of 0.15%. Mix 3 showed 8″ flow, similar to mix 2, with an even lower water/reactive powder ratio of 0.55 but higher PCE of 0.175%.

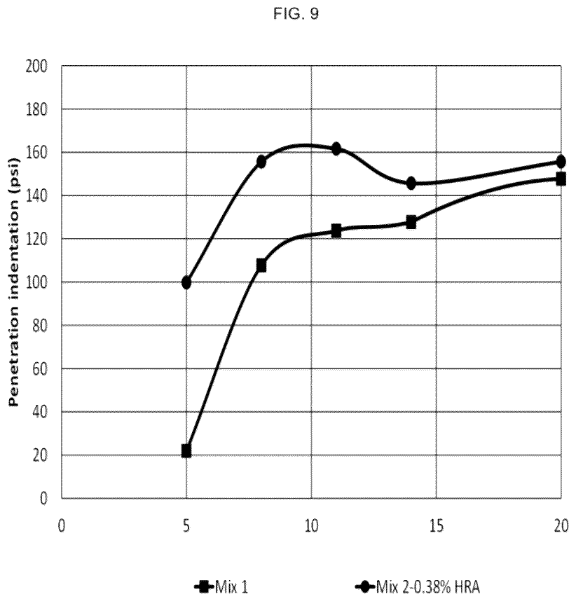

Set time measured by Gilmore needle is shown in FIG. 6. Mix 1 with higher water/reactive powder ratio of 0.65 showed a very long set time of 120 minutes. Set time was greatly reduced for mix 2 and 3 with lower water/reactive powder ratios, being around 20 minutes and 10 minutes respectively. This example demonstrated the importance of effective PCE plasticizer which allowed lower water/reactive powder ratios and faster set times.

### Example 6

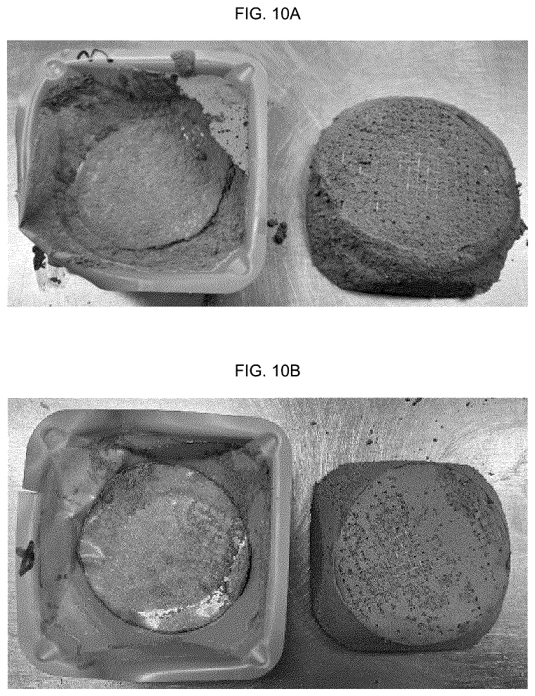

This example showed the effect of heat-resistant accelerator on panel stiffness as indicated by penetration resistance. Penetration resistance (penetration indentation) was measured with the device of FIG. 7.

Lightweight binders are desired for transportation and handling. It was achieved by using foaming agents in the mix. Typical foaming agents used in the construction industry can be used. In this example, ammonium laureth sulfate foaming agent was used. The target slurry density was 60 pcf.

HRA is gypsum powder finely interground with dextrose. It provides nucleation sites for stucco hydration thus accelerating the reaction.

In TABLE 9, both mixes had 27 parts type III Portland cement, 60 parts β-stucco, and 13 parts fly ash (with 6% CaO). The water/reactive powder ratio was 0.52, Lightweight filler/reactive powder ratio was 0.50 and expanded perlite/reactive powder ratio was 0.08. 0.26% (by weight of reactive powder) PCE plasticizer was used for each mix. Mix 1 had no HRA, while mix 2 had 0.38% HRA (by reactive powder weight). Liquid temperature was 21° C.

TABLE 9
Impact of HRA on penetration resistance
and paper peel (lightweight mixtures)

| | Mix 1 | Mix 2 |
|---|---|---|
| water/reactive powder Ratio | 0.52 | 0.52 |
| Lightweight filler/reactive powder Ratio | 0.50 | 0.50 |
| Expanded perlite/reactive powder Ratio | 0.08 | 0.08 |
| Liquids temperature (° C.) | 21 | 21 |
| Type III Portland cement parts | 27 | 27 |
| β-stucco parts | 60 | 60 |
| Fly ash parts (6% CaO) | 23 | 13 |
| reactive powder | 100 | 100 |
| Polycarboxylate ether plasticizer (% of | 0.26 | 0.26 |
| reactive powder) | | |
| HRA (% of reactive powder) | 0 | 0.38 |

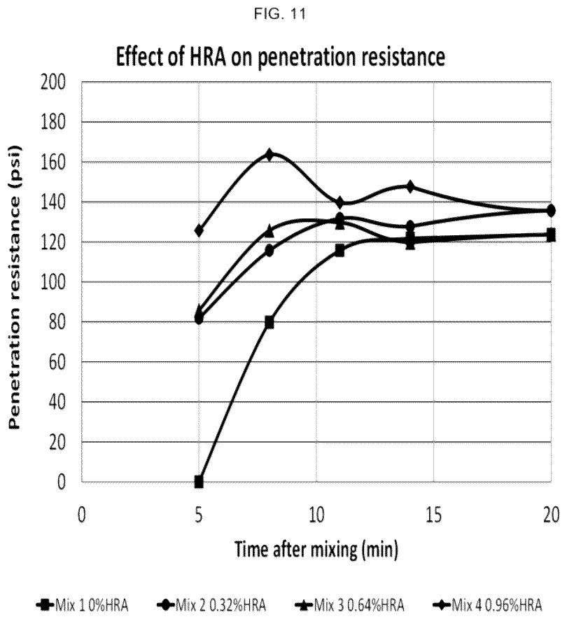

A modified ASTM C403 method (incorporated herein by reference) was used to test set time and board rigidity. ASTM C403 Standard Test Method for Time of Setting of Concrete Mixtures by Penetration Resistance is designed to test concrete set time by pushing needles of different sizes ( 1/40 inches to 1 inch diameter) into the mixture. A loading apparatus records the force at 1 inch penetration and the corresponding pressure is used to calculate set time (FIG. 8). This test method not only tests bigger area and depth, but also is quantitative. A plastic disk of 5.5 inches in diameter, and 0.7 inches in depth was used as the slurry container. The apparatus was set up so that the penetration depth was about 0.2 inches, which was deemed adequate for ½ inches panel thickness. The apparatus setup was fixed to reduce test variations.

After mixing, the slurry was quickly poured into the plastic disk, and the surface was leveled. Densities of slurries were measured and closely monitored. Penetration resistance readings were taken at specified intervals. Needle sizes might be varied as the mixtures hardened, and the penetration resistance was calculated and reported in psi.

For production lines that utilize release paper to carry slurry, how much slurry is left on the release paper at the end of production line can be used as an indication of the setting properties of the slurry. It is preferred that no slurry is left on the release paper meaning the slurry has hardened enough. A test was developed to mimic the plant production. A small piece of release paper was attached to the bottom of the weigh boat using school glue (FIG. 8A). A piece of scrim was loosely laid on the release paper. Slurry sample was poured into the weigh boat after the plastic disk for penetration resistance was filled. The weigh boat was peeled off from the patty at certain time intervals, and the amount of residual material on the paper was used as an indication of potential paper peel at the plant (FIG. 8B).

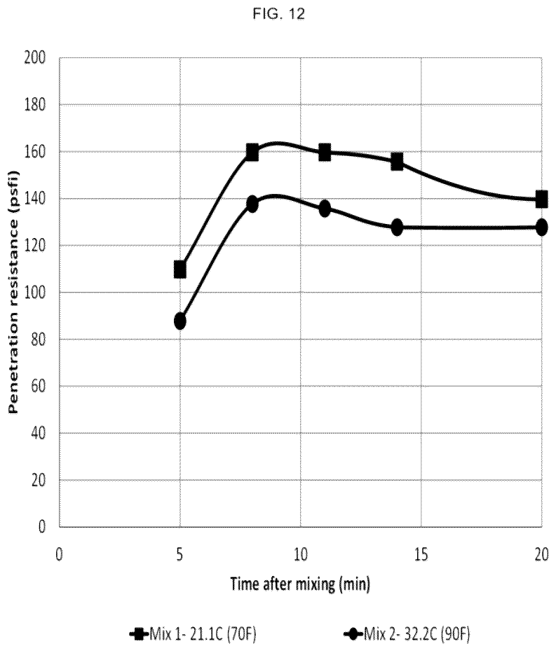

Penetration resistance test results in FIG. 9 demonstrated the impact of HRA. The two mixes had similar density of 57-58 pcf. Mix 2 containing 0.38% HRA (by weight % of reactive powder) showed 100 psi at 5 minutes, 5 times the value of mix 1 containing no HRA. At 7 minutes, mix 2 still showed 50% higher penetration resistance than mix 1. The differences decreased over time, suggesting similar final strength. The significantly greater early strength is crucial in production enabling faster line speed.

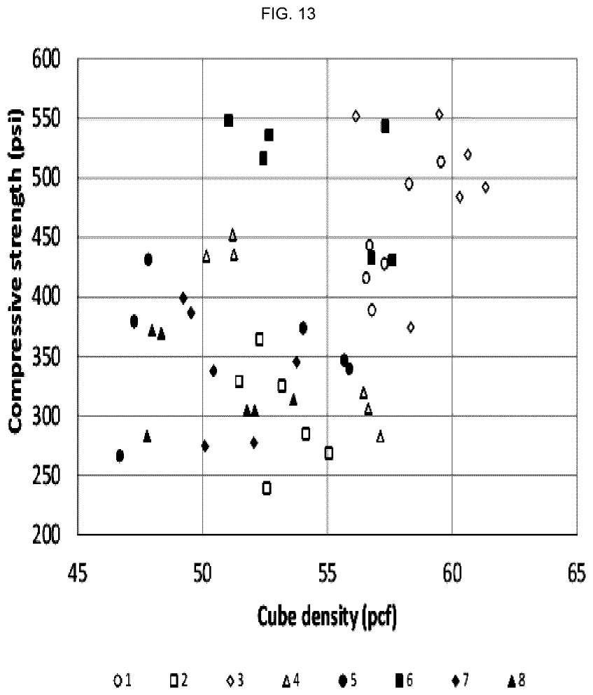

Paper peel test results at 5 minutes in FIGS. 10A, 10B showed similar findings as in penetration resistance. FIG. 10A is Mix 1 without HRA. FIG. 10B is Mix 2 with 0.63% HRA. Mix 1 containing no HRA showed sizable residue on the paper and plastic boat, whereas Mix 2 released well with only minor residue.

In TABLE 10, mixes with different levels of HRA were tested. All mixes had 26 parts type III Portland cement, 64 parts β-stucco, and 10 parts fly ash (with 6% CaO). The water/reactive powder ratio was 0.50, lightweight filler/reactive powder ratio was 0.40 and expanded perlite/reactive powder ratio was 0.065. 0.25% (by weight of reactive powder) PCE plasticizer was used for all mixes. Mix 1 had no HRA, while Mixes 2-4 had 0.38-0.96% HRA (by reactive powder weight). Liquid temperature was 21° C. A foaming agent was used and the slurry densities were 55-58 pcf for the 4 mixes.

TABLE 10
Effect of different levels of HRA on penetration resistance

| | Mix 1 | Mix 2 | Mix 3 | Mix 4 |
|---|---|---|---|---|
| | No | 0.32% | 0.64% | 0.96% |
| | HRA | HRA | HRA | HRA |
| Water/reactive powder | 0.50 | 0.50 | 0.50 | 0.50 |
| Ratio | | | | |
| Lightweight filler/ | 0.40 | 0.40 | 0.40 | 0.40 |
| reactive powder Ratio | | | | |
| Perlite/reactive | 0.065 | 0.065 | 0.065 | 0.065 |
| powder Ratio | | | | |
| Liquids temperature | 21 | 21 | 21 | 21 |
| (° C.) | | | | |
| Type III Portland | 26 | 26 | 26 | 26 |
| cement parts | | | | |
| β-stucco parts | 64 | 64 | 64 | 64 |
| Fly ash parts | 10 | 10 | 10 | 10 |
| (6% CaO) | | | | |
| reactive powder | 100 | 100 | 100 | 100 |
| HRA (% of reactive | 0 | 0.32 | 0.64 | 0.96 |
| powder) | | | | |
| Polycarboxylate ether | 0.25 | 0.25 | 0.25 | 0.25 |
| plasticizer | | | | |
| (% of reactive powder) | | | | |

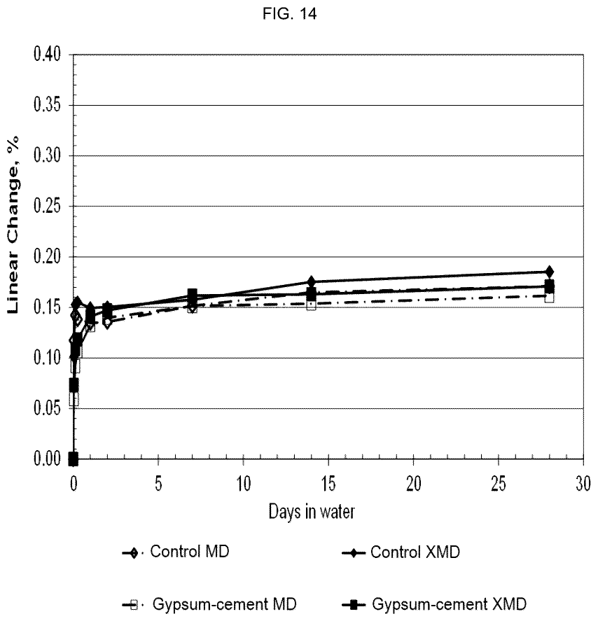

The penetration resistance results in FIG. 11 showed the impact of different levels of HRA. Mix 1 (0% HRA) showed no resistance at 5 minutes, 80 psi at 8 minutes, and 120 psi afterwards. 0.32% and 0.64% HRA had very similar impact on penetration resistance, enhancing the resistance to 80 psi at 5 minutes, and 120 psi at 8 minutes. 0.96% HRA gave even more improvement, bringing the resistance to 120 psi at 5 minutes. The 160 psi at 8 minutes might be an anomaly. Afterwards the resistance was slightly higher than the other mixes at about 140 psi. Lab testing showed going even higher on HRA content had minimal impact on penetration resistance.

### Example 7

This example demonstrates the effect of initial slurry temperature and curing temperature on penetration resistance of lightweight binders.

The two mixes both had 26 parts type III Portland cement, 64 parts stucco, and 10 parts fly ash (6% CaO). Water/reactive powder s ratio was 0.50, Lightweight filler/reactive powder ratio was 0.40, and expanded perlite/reactive powder ratio was 0.065. PCE plasticizer was 0.25% (by weight of reactive powder), and HRA was 0.32% (by weight of reactive powder). For mix 1, the initial slurry temperature was 70° F., and the curing temperature was 70° F. also. For mix 2 the initial slurry temperature and the curing temperature were 90° F. The two mixes had similar densities of 57 pcf.

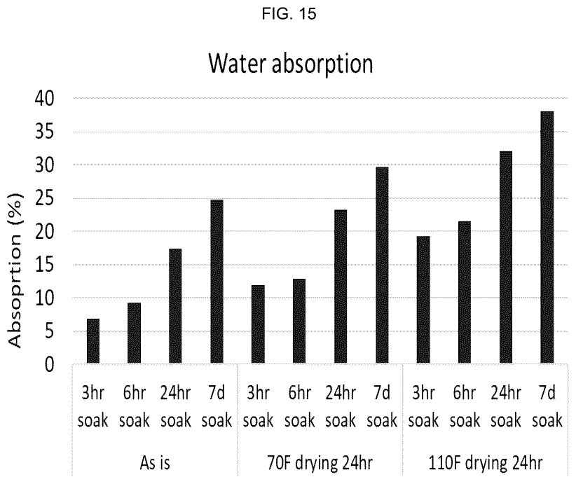

FIG. 12 shows the effect of temperature on penetration resistance. Mix 1 with lower temperature had higher penetration resistance than mix 2. Having lower temperature saves energy and is more economical.

### Example 8

In this example, binder formulations with 8 different foaming agents were examined for their impact on strength. The chemistries of the different foaming agents are listed in TABLE 11.

TABLE 11
Foaming agent chemistry

| Foaming agent | Chemistry |
|---|---|
| 1 | Ammonium alcohol ether sulfate (C8-C10) |
| 2 | Ammonium alcohol ether sulfate (C8-C10) |
| 3 | Alkyl (C10-16) ether sulfate, sodium salt |
| 4 | Ammonium salt of a sulfated linear alcohol ethoxylate |
| 5 | Ammonium alcohol ether sulfate (C8-C10) |
| 6 | (C10-C16) alcohol ethoxylate sulfated, ammonium salt |
| 7 | Ammonium alcohol ether sulfate (C8-C10) |
| 8 | Sodium (C14-16) olefin sulfonate |

All reactive powder had 25 parts by weight type III Portland cement, 50 parts by weight β-stucco, and 25 pts by weight fly ash (1% CaO). The water:reactive powder weight ratio was 0.65, the lightweight filler to reactive powder ratio was 0.62, and the expanded perlite/reactive powder ratio was 0.065 for all mixes. 0.1 wt. % PCE plasticizer (by weight of reactive powder) was used.

Cube compressive strength tests were performed on 2″×2″×2″ foamed specimens. After mixing the mixtures was poured as fast as possible into the brass cube molds and moisture cured at 65° C. After one day, the specimens were demolded and kept for moisture curing at 65° C. for 6 days and tested 7 days after casting.

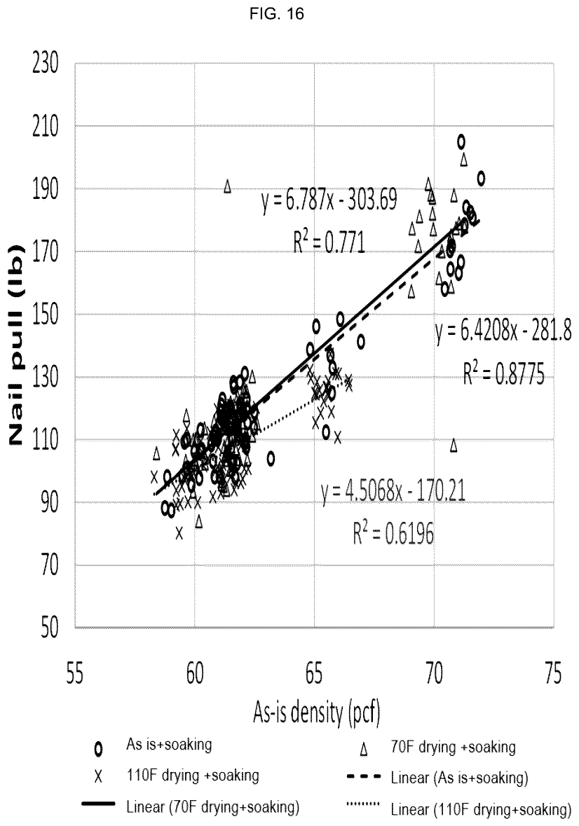

The cube compressive strength vs. cube density (measured at the time of testing) is shown in FIG. 13. The target cube density was 50-60 pcf. Distinctive strength vs. density relationships were observed for different foaming agents, even for foaming agents with similar chemistry (foaming agent 1, 2, 5, and 7). Preferred foaming agent would lead to a greater strength at similar density, or give similar density at a lower density. Foaming agent 6 was the most preferred foaming agent based on this criterion.

### Example 9

A manufacturing trial was conducted to produce lightweight cement boards on a continuous production line using formulation of the present invention. The trial formulation is shown in TABLE 12. The formulation was very similar to mix 4 in Table 4 using fly ash with 6% lime, except that no hydrated lime and/or hydrated dolomitic lime was added in this formulation. Lightweight cement boards made from the formulation were dried at 70° F. for 24 hours, and dried at 110° F. for 24 hours. After drying, the specimens were soaked in water for 3 hours, 6 hours, 24 hours or 7 days.

TABLE 12
Formulation

| | |
|---|---|
| Slurry Weight (g) | 2485 |
| Panel Thickness (in.) | 0.485 |
| Water/reactive powder Ratio | 0.50 |
| Lightweight filler/reactive powder Ratio | 0.50 |
| Expanded perlite/reactive powder Ratio | 0.08 |
| Portland cement parts by wt. per 100 | 27 |
| pbw reactive powder | |
| β-Stucco parts by wt. per 100 pbw | 60 |
| reactive powder | |
| Fly ash parts by wt. (6 wt. % CaO) | 13 |
| per 100 pbw reactive powder | |
| HRA (powder) | 0.6% of |
| | reactive powder |
| PCE plasticizer | 0.30% of |
| | reactive powder |
| Air volume (vol %) | 29 |

Linear movement, nail pull, and flexural strength were the three properties most impacted by water exposure. Water durability is shown with nail pull results and/or flexural strength testing.

### Linear Movement

Linear movement after water exposure was measured on the panels and compared to control panel. Panels were cut into five 4 inch×12 inch specimens, with the 12 inches parallel to MD (machine direction) or XMD (cross machine) directions. Brass buttons were adhered to both sides of the specimens and positioned exactly 10 inches apart with a reference bar. The specimens were dried at 110° F. for 24 hours, then soaked in water for up to 28 days. Length measurements were taken at different time intervals.

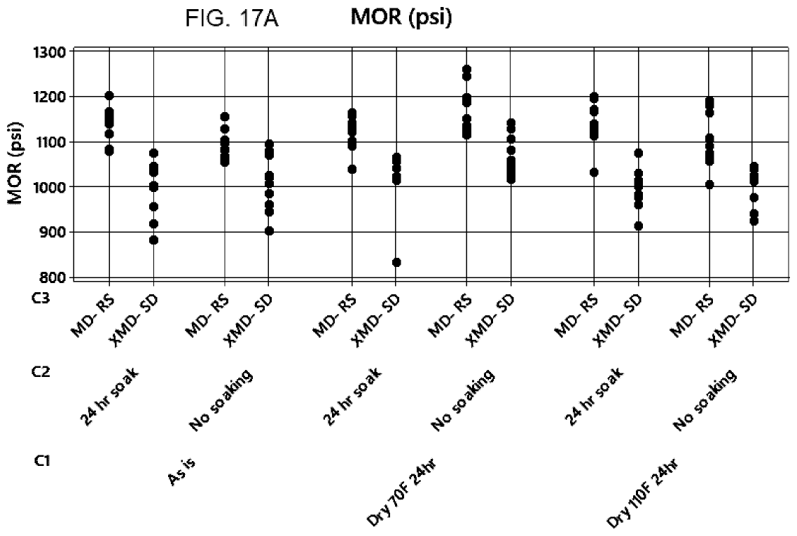

The results are shown in FIG. 14. The control panel was a commercially available cement board product. It showed about 0.18% expansion at 28 days. The lightweight binder composition of this invention showed slightly lower expansion than the control formulation. This encouraging result showed the excellent water durability of the new binder.

### Nail Pull

With gypsum being very sensitive to moisture, three different drying schemes were used: as-is (no drying), drying at 70° F. for 24 hours, and drying at 110° F. for 24 hours. After drying, the specimens were soaked in water for 3 hours, 6 hours, 24 hours, or 7 days (see Table 12). 10 specimens were tested for each condition.

TABLE 13 shows Nail Pull conditioning schemes.

TABLE 13
Nail pull conditioning schemes

| Drying | Soaking |
|---|---|
| As-is (no drying) | 3, 6, 24 hrs, 7 days |
| Drying 70° F. for 24 hrs | |
| Drying 110° F. for 24 hrs | |

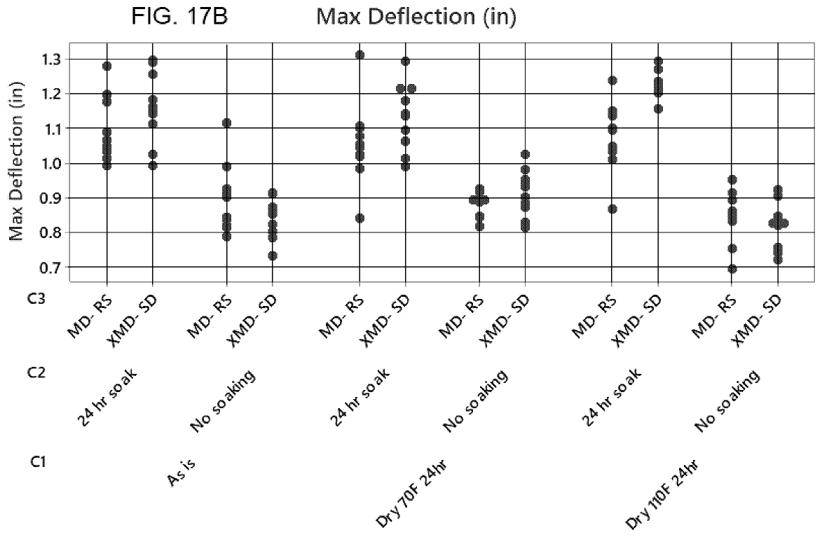

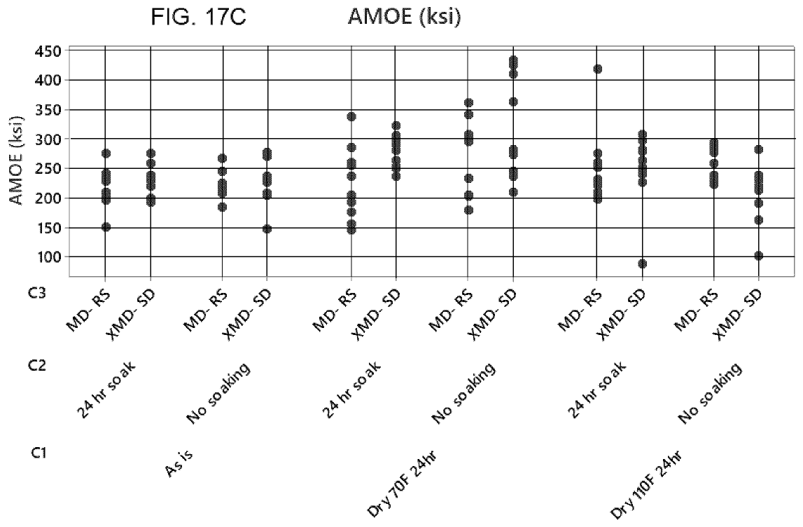

FIG. 15 showed the water absorption results for the nail pull samples. Significant water uptake was witnessed for the nail pull samples, up to 25-40% after 7 days soaking. The individual nail pull data points are plotted against the as-is density, see FIG. 16. For all three conditioning schemes, there was a strong correlation between nail pull values and as-is densities, independent of soaking time. This is very encouraging as it demonstrated the excellent water durability of the formulation, where performance degradation was not observed with prolonged water exposure. Drying did not seem to have a significant impact on nail pull results.

### Flexural Strength

For flexural strength testing, the conditioning schemes were similar to that of nail pull testing (Table 14). The drying was as-is (no drying), drying at 70° F. for 24 hours, and drying at 110° F. for 24 hours. Soaking time was 0 or 24 hours. The top surface of the panel was tested for machine direction (MD) in flexural tension, and the bottom surface of the panel was tested for cross machine direction (XMD) in flexural tension. 10 specimens were tested for each condition.

TABLE 14 shows Flexural testing conditioning schemes.

TABLE 14
Flexural testing conditioning schemes

| Drying | Soaking |
|---|---|
| As-is (no drying) | 0 or 24 hrs |
| Drying 70° F. for 24 hrs | |
| Drying 110° F. for 24 hrs | |

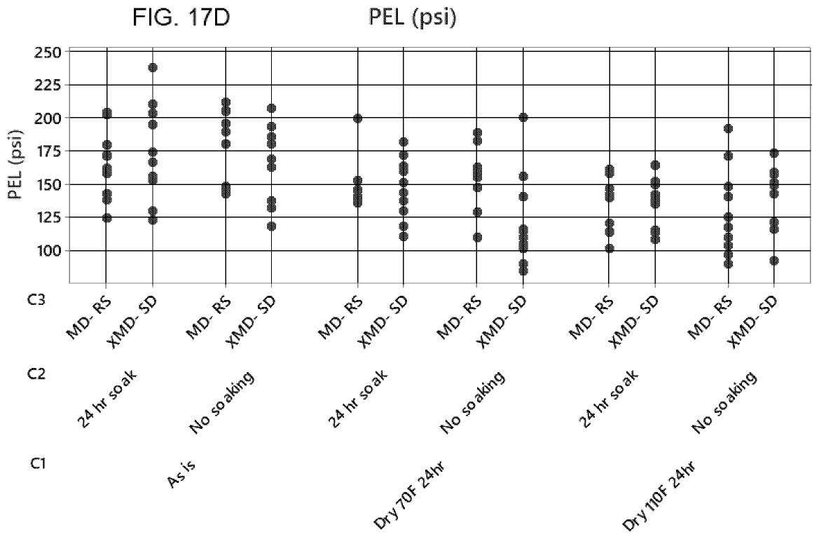

Modulus of rupture (MOR), maximum displacement (DMAX), apparent modulus of elasticity (AMOE), proportional elastic limit (PEL) are tested in accordance with ASTM C947 and demonstrated in FIG. 17. Panels were cut into five 4″×12″ specimens, with the 12″ parallel to MD (machine direction) or XMD (cross machine) directions. The specimens were subjected to 3-point loading flexural testing with a span length of 10″. A uniform load of a crosshead speed of 0.5″/min was applied until a significant drop in load (50%) was exhibited or no increase in load was observed with 0.25″ deflection. MOR, AMOE, and PEL were calculated in accordance with ASTM C947, DMAX corresponded to the deflection at the peak load.

It is observed that water soaking did not have a significant impact on MOR. Drying prior to soaking also had a negligible effect on MOR. For maximum deflection at failure, soaking led to greater values, meaning the panels became more ductile with soaking. When looking at AMOE and PEL, which are more of the matrix property, soaking did not result in lower performance.

### Sem Images

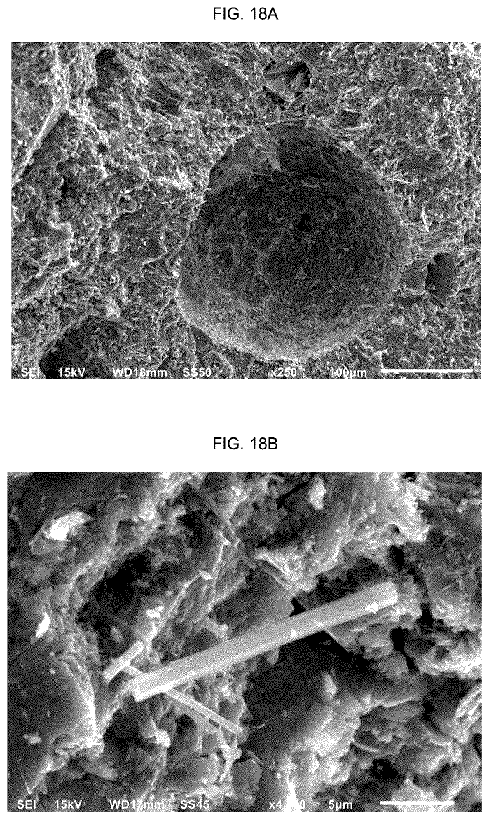

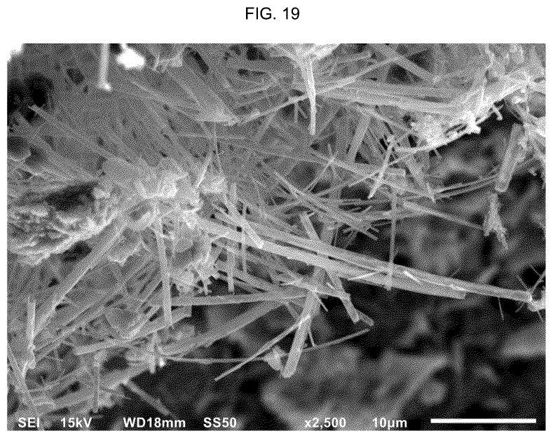

Scanning electron microscopy (SEM) analysis was completed for a sample that was soaked for 7 days. Even though ettringite was observed at some locations, its presence was not prevalent (FIG. 18A, FIG. 18B which are two different magnifications of a sample). It took some effort to locate ettringite in the soaked sample (FIG. 19). This demonstrated the robustness of the formulation with water exposure.

### CLAUSES OF THE INVENTION

The following clauses describe various aspects of the invention.

Clause 1. A binder composition comprising a mixture of:
a) a reactive powder comprising
   cement, preferably Portland cement, at about 10-40 wt. % of the reactive powder,
   β-stucco at about 30-75 wt. % of the reactive powder, and
   pozzolanic material at about 5-30 wt. % of the reactive powder, wherein the pozzolanic material comprises fly ash,
b) a plasticizer in an amount equal to about 0.05-3 wt. %, preferably 0.1-3 wt. %, of the reactive powder, and
c) water, wherein the reactive powder:water weight ratio is 100:40-70.

Clause 2. The binder composition of clause 1, wherein the fly ash comprises 0.1-30 wt. % calcium oxide, preferably 0.1-24 wt. % calcium oxide, more preferably up to 18 wt. % calcium oxide.

Clause 3. The binder composition of clause 1, wherein the fly ash comprises up to 6 wt. % calcium oxide, preferably up to 1 wt. % calcium oxide, preferably less than 1 wt. % calcium oxide.

Clause 4. The binder composition of clause 1, further comprising hydrated lime and/or hydrated dolomitic lime at up to about 3 wt. % of the reactive powder.

Clause 5. The binder composition of clause 1, having an absence of silica fume.

Clause 6. The binder composition of clause 1, wherein the plasticizer is present in an amount equal to about 0.5-3 wt. % of the reactive powder.

Clause 7. The binder composition of clause 1, wherein the plasticizer is present in an amount equal to about 0.1-1 wt. % of the reactive powder.

Clause 8. The binder composition of clause 1, wherein the plasticizer comprises a polycarboxylate ether (PCE) plasticizer.

Clause 9. The binder composition of clause 1, further comprising aluminum sulfate in an amount equal to about 0.1-1 wt. % of the reactive powder.

Clause 10. The binder composition of clause 1, further comprising a nucleating agent in an amount equal to preferably 0.1-1.5 wt. % of the reactive powder.

Clause 11.The binder composition of clause 10, wherein the nucleating agent comprises a finely ground gypsum powder with or without other chemicals.

Clause 12. The binder composition of clause 1, further comprising a retarder in an amount equal to about 0.1-1.5 wt. % of the reactive powder.

Clause 13. The binder composition of clause 12, wherein the retarder comprises one or more of sodium citrate, citric acid, gluconic acid, DTPA, potassium tartrate and sodium tartrate.

Clause 14.The binder composition of clause 1, comprising no triethanolamine (“TEA”).

Clause 15. The binder composition of clause 1, wherein the fly ash comprises Class F fly ash.

Clause 16. A lightweight composition comprising the binder composition of any of clauses 1 to 15, further comprising lightweight filler, preferably expanded perlite, expanded clay, expanded shale, and/or expanded plastic beads, wherein the lightweight filler:reactive powder weight ratio is 0.01-1.75:1.00.

Clause 17. A lightweight composition comprising the binder composition of any of clauses 1 to 15, further comprising one or more of aluminum sulfate, nucleating agent, retarder, alkanolamine, air-entraining agent, metal phosphate, inorganic secondary set accelerator, lightweight filler, secondary filler, and scrim.

Clause 18. A process of minimizing or reducing delayed ettringite formation in a binder composition of any of clauses 1 to 15 comprising:

adding pozzolanic material which comprises fly ash to a mixture of cement and B-stucco to make a reactive powder,

adding plasticizer to the reactive powder,

adding water and one or more lightweight fillers to the mixture,

preferably in a 1:0.40-0.70 reactive powder:water weight ratio, at 40-120° F., preferably 45-100° F., more preferably 50-90° F., with a lightweight filler:reactive powder weight ratio of 0.01-1.0,

adding entrained air at 5-50 vol. %, preferably 10-45 vol. %, most preferably 20-40 vol. %,

applying the mixed binder and water in a continuous production line to form a board product.

Clause 19. A method of providing a lightweight cement board comprising:

forming a mixture of:
a) a reactive powder comprising
   cement, preferably Portland cement, at about 10-40 wt. % of the reactive powder,
   β-stucco at about 30-75 wt. % of the reactive powder, and
   pozzolanic material at about 5-30 wt. % of the reactive powder, wherein the pozzolanic material comprises fly ash,
b) a plasticizer in an amount equal to about 0.05-3 wt. %, preferably 0.1-3 wt. %, of the reactive powder, and
c) water, wherein the reactive powder:water weight ratio is 100:40-70
d) 5-50 vol. %, on a wet basis, entrained air; and
e) optional additive selected from at least one member of the group consisting of aluminum sulfate, nucleating agent, retarder, alkanolamine, air-entraining agent, metal phosphate, inorganic secondary set accelerator, lightweight filler, secondary filler, and scrim;
   under conditions which provide an initial slurry temperature of at least about 40° F. (4.4° C.), preferably 40-120° F. (4.4-48.9° C.).

Clause 20. The method of clause 19, further comprising setting the slurry to form a product having a product density of 30 to 120 pcf.

Clause 21. The method of clause 19, further comprising setting the slurry to form a product having a product density of 40 to 80 pcf.

Clause 22. A cement board, having a density of about 30 to 120 pcf, made from the composition of clause 16.

Clause 23. A cement board having a density of about 40 to 80 pcf and having a continuous phase resulting from the curing of an aqueous mixture comprising:
a) a reactive powder comprising
   cement, preferably Portland cement, at about 10-40 wt. % of the reactive powder,
   β-stucco at about 30-75 wt. % of the reactive powder, and
   pozzolanic material at about 5-30 wt. % of the reactive powder, wherein the pozzolanic material comprises fly ash,
b) a plasticizer in an amount equal to about 0.05-3 wt. %, preferably 0.1-3 wt. %, of the reactive powder, and
c) water, wherein the reactive powder:water weight ratio is 100:40-70
d) 5-50 vol. %, on a wet basis, entrained air; and
e) optional additive selected from at least one member of the group consisting of aluminum sulfate, nucleating agent, retarder, alkanolamine, air-entraining agent, metal phosphate, inorganic secondary set accelerator, lightweight filler, secondary filler, and scrim.

Clause 24. The board of clause 23, wherein the board has top and bottom surfaces reinforced with reinforcing mesh.

Clause 25. The board of clause 23, wherein the reinforcing mesh comprises inorganic material.

Clause 26. The board of clause 23, wherein the reinforcing mesh comprises organic material.

Clause 27. The board of clause 23, wherein the reinforcing mesh comprises an alkali resistant fiberglass.

Clause 28. The board of clause 23, wherein the board has a thickness of about 0.15 to 2 inches, preferably 0.20 to 1.00 inches, most preferably 0.25 to 0.75 inches.

Clause 29. The board of clause 23, wherein the board has nail pull strength of at least 60 lbs (267 Newtons) per ASTM C1325.

Clause 30. The board of clause 23, wherein the board has nail pull strength of greater than 90 lbs (400 Newtons) per ASTM C1325.

Clause 31. The board of clause 23, wherein the board has flexural strength of at least 400 psi (2.76 MPa) per ASTM C947.

Clause 32. The board of clause 23, wherein the board has flexural strength of greater than 750 psi (5.17 MPa) per ASTM C947.

Clause 33. The board of clause 23, wherein the board has shear bond strength to ceramic tile and cement mortar of at least 50 psi (0.34 MPa) per ANSI A118.10.

Clause 34. A floor system comprising cement boards of clause 23, which pass a minimum of first three cycles of the test per ASTM C627 for structural durability.

Clause 35. The binder composition of any of clauses 1-15, wherein the binder composition is water durable and or rapid setting.

Clause 36. The lightweight composition of any of clauses 16-17, wherein the board is water durable and or rapid setting.

Clause 37. The cement board of any of clauses 22-33, wherein the board is water durable and or rapid setting.

Although the preferred embodiments for implementing the present invention are described, it will be understood by those skilled in the art to which this disclosure is directed that modifications and additions may be made to the invention without departing from its spirit and scope.

1. A binder composition comprising a mixture of:
a) a reactive powder comprising
cement at about 10-40 wt. % of the reactive powder,
β-stucco at about 30-75 wt. % of the reactive powder, and
pozzolanic material at about 5-30 wt. % of the reactive powder, wherein the pozzolanic material comprises fly ash,
b) a plasticizer in an amount equal to about 0.05-3 wt. %, and
c) water, wherein the reactive powder:water weight ratio is 100:40-70.

2. The binder composition of claim 1, wherein the fly ash comprises 0.1-30 wt. % calcium oxide.

3. The binder composition of claim 1, wherein the fly ash comprises up to 6 wt. % calcium oxide.

4. The binder composition of claim 1, further comprising hydrated lime and/or hydrated dolomitic lime at up to about 3 wt. % of the reactive powder.

5. The binder composition of claim 1, having an absence of silica fume.

6. The binder composition of claim 1, wherein the plasticizer is present in an amount equal to about 0.5-3 wt. % of the reactive powder.

7. The binder composition of claim 1, wherein the plasticizer is present in an amount equal to about 0.1-1 wt. % of the reactive powder.

8. The binder composition of claim 1, wherein the plasticizer comprises a polycarboxylate ether plasticizer.

9. The binder composition of claim 1, further comprising at least one ingredient selected from the group consisting of:
aluminum sulfate in an amount equal to about 0.1-1 wt. % of the reactive powder;
a nucleating agent; and
a retarder in an amount equal to about 0.1-1.5 wt. % of the reactive powder.

10. A lightweight composition comprising the binder composition of claim 1, further comprising lightweight filler, wherein the lightweight filler:reactive powder weight ratio is 0.01-1.75:1.00.

11. A lightweight composition comprising the binder composition of claim 1, further comprising one or more of aluminum sulfate, nucleating agent, retarder, alkanolamine, air-entraining agent, metal phosphate, inorganic secondary set accelerator, lightweight filler, secondary filler, and scrim.

12. A process of minimizing or reducing delayed ettringite formation in a binder composition of claim 1, comprising:
adding pozzolanic material which comprises fly ash to a mixture of cement and β-stucco to make a reactive powder,
adding plasticizer to the reactive powder,
adding water and one or more lightweight fillers to the mixture at 40-120° F., with a lightweight filler:reactive powder weight ratio of 0.01-1.0,
adding entrained air at 5-50 vol. %,
applying the mixed binder and water in a continuous production line to form a board product.

13. A method of providing a lightweight cement board comprising:
forming a mixture of:
a) a reactive powder comprising
cement at about 10-40 wt. % of the reactive powder,
β-stucco at about 30-75 wt. % of the reactive powder, and
pozzolanic material at about 5-30 wt. % of the reactive powder, wherein the pozzolanic material comprises fly ash,
b) a plasticizer in an amount equal to about 0.05-3 wt. %, preferably 0.1-3 wt. %, of the reactive powder, and
c) water, wherein the reactive powder:water weight ratio is 100:40-70
d) 5-50 vol. %, on a wet basis, entrained air; and
e) optional additive selected from at least one member of the group consisting of aluminum sulfate, nucleating agent, retarder, alkanolamine, air-entraining agent, metal phosphate, inorganic secondary set accelerator, lightweight filler, secondary filler, and scrim;
under conditions which provide an initial slurry temperature of at least about 40° F.

14. The method of claim 19, further comprising setting the slurry to form a product having a product density of 30 to 120 pcf.

15. A cement board, having a density of about 30 to 120 pcf, made from the composition of claim 16.

16. A cement board having a density of about 40 to 80 pcf and having a continuous phase resulting from the curing of an aqueous mixture comprising:
a) a reactive powder comprising
cement at about 10-40 wt. % of the reactive powder,
β-stucco at about 30-75 wt. % of the reactive powder, and
pozzolanic material at about 5-30 wt. % of the reactive powder, wherein the pozzolanic material comprises fly ash,
b) a plasticizer in an amount equal to about 0.05-3 wt. % of the reactive powder, and
c) water, wherein the reactive powder:water weight ratio is 100:40-70
d) 5-50 vol. %, on a wet basis, entrained air; and
e) optional additive selected from at least one member of the group consisting of aluminum sulfate, nucleating agent, retarder, alkanolamine, air-entraining agent, metal phosphate, inorganic secondary set accelerator, lightweight filler, secondary filler, and scrim.

17. The board of claim 16, wherein the board has top and bottom surfaces reinforced with reinforcing mesh.

18. The board of claim 16, wherein the board has a thickness of about 0.15 to 2 inches.

19. The board of claim 18, wherein the board has at least one of the following properties:
nail pull strength of at least 60 lbs per ASTM C1325;
flexural strength of at least 400 psi per ASTM C947; and
shear bond strength to ceramic tile and cement mortar of at least 50 psi per ANSI A118.10.

20. A floor system comprising cement boards of claim 18, which pass a minimum of first three cycles of the test per ASTM C627 for structural durability.
